(19) United States
(12) Patent Application Publication
(10) Pub. No.: US 2019/0320122 A1
(43) Pub. Date: Oct. 17, 2019

(54) CONTROL APPARATUS, IMAGE CAPTURING APPARATUS, CONTROL METHOD, AND NON-TRANSITORY COMPUTER-READABLE STORAGE MEDIUM

(71) Applicant: CANON KABUSHIKI KAISHA, Tokyo (JP)

(72) Inventor: Reiji Hasegawa, Kawasaki-shi (JP)

(21) Appl. No.: 16/376,074

(22) Filed: Apr. 5, 2019

(30) Foreign Application Priority Data
Apr. 13, 2018 (JP) 2018-077214

(51) Int. Cl. H04N 5/232; G06T 7/70; G02B 7/28; G02B 7/38

(52) U.S. Cl. CPC H04N 5/232122; G06T 7/70; G02B 7/38; H04N 5/232127; G02B 7/285; H04N 5/23218

(57) ABSTRACT

A control apparatus includes a first focus detector (255, 212) which performs focus detection by phase difference detection using a first sensor (254) that receives a light ray formed by an image capturing optical system, a second focus detector (204, 212) which performs the focus detection using a second sensor (201) that receives a light ray formed by the image capturing optical system, a calculator (212a) which calculates correction information corresponding to a difference between first and second signals from the first and second detectors, a memory (209) which stores the correction information, a controller (212b) which performs focus control based on the first signal in a first area and performs the focus control based on the second signal and the correction information in a second area, and an identifier (212) which identifies an object, and the memory stores the correction information for each object.

### BACKGROUND OF THE INVENTION

### Field of the Invention

The present invention relates to an image capturing apparatus that performs focusing by a phase difference detection method.

### Description of the Related Art

Conventionally, image capturing apparatuses that perform autofocusing (AF) by a phase difference detection method are known. As AF based on the phase difference detection method, there are AF using a secondary optical system and an AF sensor (secondary optical system AF), and AF using an image sensor (imaging-plane phase difference AF).

In the secondary optical system AF, it is possible to perform AF control while a user observes an optical viewfinder. However, focus detection can be performed only in the vicinity of the center of an image due to limitations of a mirror and the secondary optical system. On the other hand, in the imaging-plane phase difference AF, the AF control can be performed in a wider range than the AF using the secondary optical system and the AF sensor. However, focus detection can only be performed while imaging is performed with the image sensor with mirror up, and the user cannot observe the finder during the focus detection.

Therefore, for example, Japanese Patent Laid-open No. 2014-142372 discloses an image capturing apparatus that uses the secondary optical system AF near the center of an image and uses the imaging-plane phase difference AF on the periphery of the image.

Since the two AF principles of the secondary optical system AF and the imaging-plane phase difference AF are different from each other, there is also a difference in information used for the focus detection. In these two AFs, ranges of two images with different phases and pupils are different. In general, since the AF sensor and the image sensor have different pixel pitches, a spatial frequency of an object is different. Also, when the focus detection is performed by the secondary optical system, an aperture stop is set to a full-open state. However, for a captured image (still image), when the aperture stop needs to be narrowed due to the still image, an aperture value differs according to the two AFs. Also, depending on a position in a screen (image), the shape of the pupil changes due to optical characteristics, vignetting or the like.

As described above, there is a difference between the two focus detection results, and it is not possible to obtain the same focus detection result strictly, which is a problem when the two AFs are selectively used. For example, when the two AFs are selectively used in an area within the screen, when an object moves from the center of the screen to the periphery, the difference in focus detection result can be recognized by the user. Also, when the object exists in the vicinity of the transition area of the two AFs, it is unstable which AF of the two AFs is used depending on the situation. For this reason, the image capturing apparatus may alternately use different focus detection results of two AFs irregularly and may perform a hunting operation, resulting in an inferior quality. Accordingly, high-speed and high-accuracy focus detection cannot be performed.

Therefore, it is conceivable to correct the difference between the focus detection results by the two AF methods. However, there are many factors that cause optical differences in each of the two AF methods, and if correction is made for each of these factors, it is necessary to prepare a correction table for each factor, and the required capacity becomes lame, which is difficult. On the other hand, in order to actually calculate and correct each of the changes in each factor requires enormous amounts of computation, resulting in problems such as an increase in processing load or a delay in operation.

In the image capturing apparatus disclosed in Japanese Patent Laid-open No. 2014-142372, while the two AF methods are selectively used according to temperature, humidity, shape change of the optical system, and the like, it is not possible to solve the aforementioned problems such as a hunting operation in the case where the object is in the vicinity of the transition area.

### SUMMARY OF THE INVENTION

The present invention provides a control apparatus, an image capturing apparatus, a control method, and a non-transitory computer-readable storage medium that can perform focus detection with high speed and high accuracy at low cost.

A control apparatus as one aspect of the present invention includes a first focus detector configured to perform focus detection by phase difference detection using a first sensor that receives a light ray formed by an image capturing optical system, a second focus detector configured to perform focus detection by phase difference detection using a second sensor that receives a light ray formed by the image capturing optical system, a calculator configured to calculate correction information corresponding to a difference between a first signal from the first detector and a second signal from the second detector, a memory configured to store the correction information calculated by the calculator, a controller configured to perform focus control based on the first signal in a first area and perform the focus control based on the second signal and the correction information stored in the memory in a second area, and an identifier configured to identify an object, and the memory is configured to store the correction information for each object identified by the identifier.

An image capturing apparatus as another aspect of the present invention includes a first sensor configured to receive a light ray formed by an image capturing optical system, a second sensor configured to receive a light ray formed by the image capturing optical system, and the control apparatus.

A control method as another aspect of the present invention includes the steps of performing first focus detection by phase difference detection using a first sensor that receives a light ray formed by an image capturing optical system, performing second focus detection by phase difference detection using a second sensor that receives a light ray formed by the image capturing optical system, calculating correction information corresponding to a difference between a first signal obtained by the first detection and a second signal obtained by the second detection, storing the calculated correction information, performing focus control based on the first signal in a first area, performing the focus control based on the second signal and the stored correction information, and identifying an object, and the step of storing the correction information includes storing the correction information for each object identified by the identifier.

A non-transitory computer-readable storage medium as another aspect of the present invention stores a program causing a computer to execute the control method.

Further features of the present invention will become apparent from the following description of exemplary embodiments with reference to the attached drawings.

### BRIEF DESCRIPTION OF THE DRAWINGS

FIG. 1 is a block diagram illustrating a configuration of an image capturing apparatus in each embodiment.

FIGS. 2A to 2C are pixel configuration diagrams of an image sensor in each embodiment.

FIG. 3 is a flowchart illustrating an image capturing process in each embodiment.

FIG. 4 is a flowchart illustrating a still image capturing process in each embodiment.

FIGS. 5A to 5C are explanatory diagrams of focus detection areas in each embodiment.

FIG. 6 is a flowchart illustrating a focus detection process by the image sensor in each embodiment.

FIGS. 7A to 7E are explanatory diagrams of an offset information table in each embodiment.

FIGS. 8A to 8C are diagrams illustrating the relationship between an object and the focus detection area in a second embodiment and a third embodiment.

FIG. 9 is a diagram illustrating the relationship between a focus detection frame of the image sensor and an image height in a fifth embodiment.

FIGS. 10A to 10F are explanatory diagrams of pixel combination in each embodiment.

FIG. 11 is a diagram illustrating the relationship between the object, the lens, and the image sensor in each embodiment.

FIGS. 12A to 12C are explanatory diagrams of focus detection of a phase difference method by an AF sensor in each embodiment.

FIGS. 13A to 13C are explanatory views of the focus detection areas in each embodiment.

FIGS. 14A to 14C are explanatory diagrams of image signals acquired from the focus detection areas in each embodiment.

FIGS. 15A to 15C are explanatory diagrams of a correlation amount in the focus detection process in each embodiment.

### DESCRIPTION OF THE EMBODIMENTS

Exemplary embodiments of the present invention will be described below with reference to the accompanied drawings.

### First Embodiment

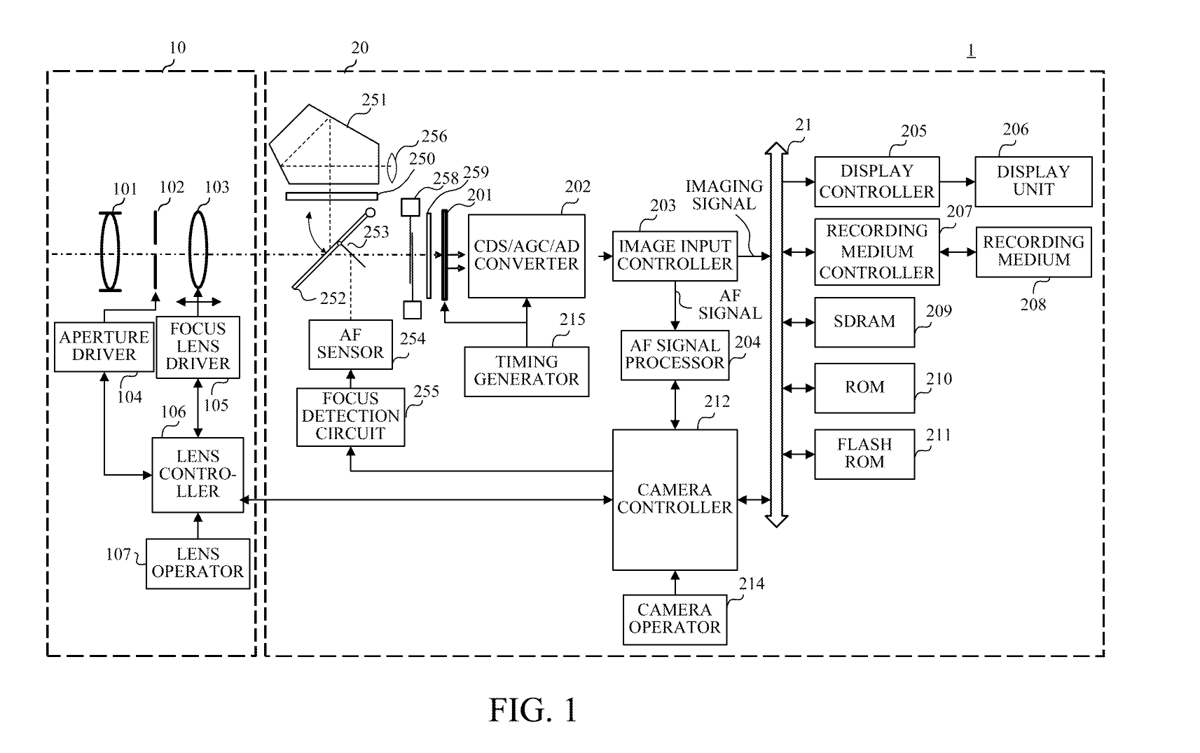

First, with reference to FIG. 1, an image capturing apparatus in a first embodiment of the present invention will be described. FIG. 1 is a block diagram illustrating a configuration of an image capturing apparatus 1. The image capturing apparatus 1 is a lens interchangeable camera including a lens apparatus (interchangeable lens) 10 and a camera body (image capturing apparatus body) 20 to which the lens apparatus 10 is removably attached. Therefore, in the image capturing apparatus 1, a lens controller 106 that totally controls the overall operation of the lens apparatus 10 and a camera controller 212 that totally controls the overall operation of the camera body 20 can communicate information with each other. However, the present invention is not limited to this, and can also be applied to an image capturing apparatus in which a lens apparatus and a camera body are integrally formed.

First, the configuration of the lens apparatus 10 will be described. The lens apparatus 10 includes a fixed lens (first lens unit) 101, an aperture stop 102, a focus lens 103, an aperture driver 104, a focus lens driver 105, the lens controller 106, and a lens operator 107. The fixed lens 101, the aperture stop 102, and the focus lens 103 constitute an image capturing optical system.

The aperture stop 102 is driven by the aperture driver 104 and controls an incident light amount on an image sensor (image pickup element) 201, which will be described below. The focus lens (imaging lens) 103 is driven by the focus lens driver 105 and adjusts a focus to be formed on the image sensor 201, which will be described below. The aperture driver 104 and the focus lens driver 105 are controlled by the lens controller 106, and determine an opening amount of the aperture stop 102 and a position of the focus lens 103. The lens controller 106 controls the aperture driver 104 and the focus lens driver 105 according to a control command or control information received from the camera controller 212 described below, and transmits lens control information to the camera controller 212.

Next, the configuration of the camera body 20 will be described. The camera body 20 is configured to be able to acquire an imaging signal from a light beam having passed through the image capturing optical system of the lens apparatus 10. The light beam having passed through the image capturing optical system of the lens apparatus 10 is guided to a rotatable quick return mirror 252. The central portion of the quick return mirror 252 is a half mirror, and a part of the light beam is transmitted when the quick return mirror 252 is down (while the quick return mirror 252 is moved downward in FIG. 1 to be inserted into the optical path). The transmitted light beam is reflected by a sub mirror 253 disposed on the quick return mirror 252 and guided to an AF sensor (phase difference AF sensor) 254 which is an autofocus adjuster. The AF sensor 254 is controlled by a focus detection circuit 255.

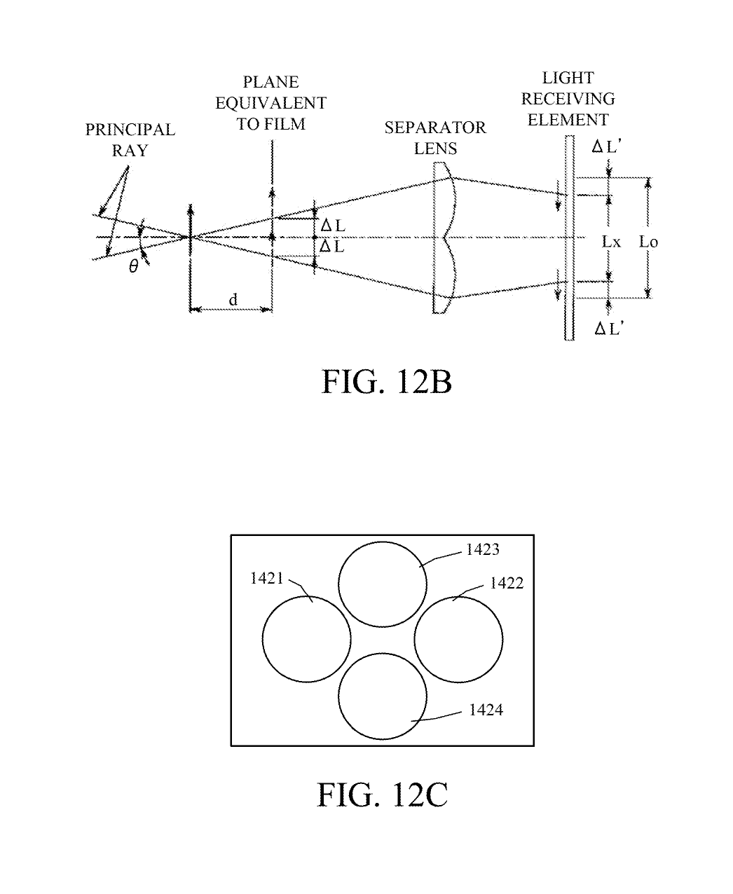

As will be described below with reference to FIGS. 12A to 12C. the AF sensor 254 may have a plurality of configurations in which a separator lens and a light receiving element are arranged vertically in the screen and arranged side by side. In this embodiment, the focus detection with such a configuration is referred to as “focus detection by the AF sensor 254 ”. In this embodiment, the focus detection circuit 255 and the camera controller 212 constitute a first focus detector that performs the focus detection by phase difference detection using the AF sensor 254.

On the other hand, the imaging light beam reflected by the quick return mirror 252 forms an image on a mat screen 250, and the user can observe it from the upper side through a pentaprism 251 and an eyepiece 256.

When the quick return mirror 252 is moved upward (i.e., it is moved up as indicated by an arrow in FIG. 1 toward the pentaprism 251), the light beam from the lens apparatus 10 is imaged on the image sensor 201 via a focal plane shutter (mechanical shutter) 258 and a filter 259. The filter 259 has two functions. One is a function of cutting infrared rays, ultraviolet rays, and the like to guide only a visible light ray to the image sensor 201, and the other is a function as an optical low-pass filter. Further, the focal plane shutter 258 includes a front curtain and a rear curtain, and is a light blocking unit that controls the transmission and blocking of the light beam from the lens apparatus 10.

The light beam having passed through the image capturing optical system of the lens apparatus 10 forms an image on the light receiving surface of the image sensor 201 and is converted into signal charges depending on to the incident light amount by a photodiode of the image sensor 201. The signal charges accumulated in each photodiode are sequentially read out from the image sensor 201 as voltage signals depending on the signal charges based on drive pulses supplied from a timing generator 215 in accordance with commands from the camera controller 212.

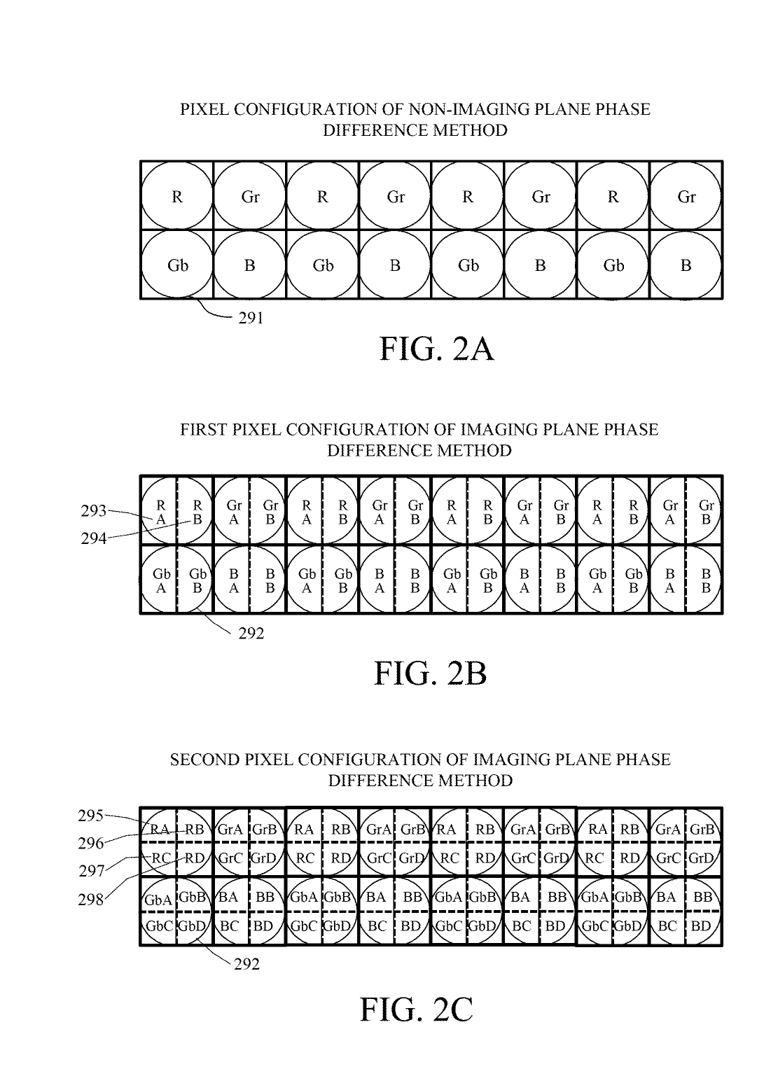

FIGS. 2A to 2C are pixel configuration diagrams of the image sensor 201. FIG. 2A illustrates a pixel configuration (a pixel configuration of a non-imaging plane phase difference AF method) of an image sensor as a comparative example. On the other hand, FIG. 2B illustrates a pixel configuration (a pixel configuration of the imaging-plane phase difference AF method) of the image sensor 201 in this embodiment. FIG. 2C is a modification of the pixel configuration of the image sensor 201 in this embodiment.

As illustrated in FIG. 2B, the image sensor 201 is provided with two photodiodes 293 and 294 for one microlens 292 (i.e., the two photodiodes share one microlens). The image sensor 201 is configured so that the light beam incident on the image sensor 201 is separated by the microlens 292 and two signals for imaging and AF can be taken out by forming an image with these two photodiodes 293 and 294. A signal (A+B signal) obtained by adding (combining) the signals of the two photodiodes 293 and 294 is an imaging signal, and individual signals (A signal and B signal) of the photodiodes 293 and 294 are two image signals (AF signal). An AF signal processor 204 described below performs a correlation calculation on the two image signals (AF signals) to calculate an image shift amount and various pieces of reliability information. In this embodiment, such focus detection is referred to as “focus detection by the image sensor 201”. In this embodiment, the AF signal processor 204 and the camera controller 212 constitute a second focus detector that performs focus detection by the phase difference detection using the image sensor 201.

The image sensor 201 may have the pixel configuration illustrated in FIG. 2C. In FIG. 2C, four photodiodes 295, 296, 297, and 298 are provided for one microlens 292 (i.e., the four photodiodes share one microlens).

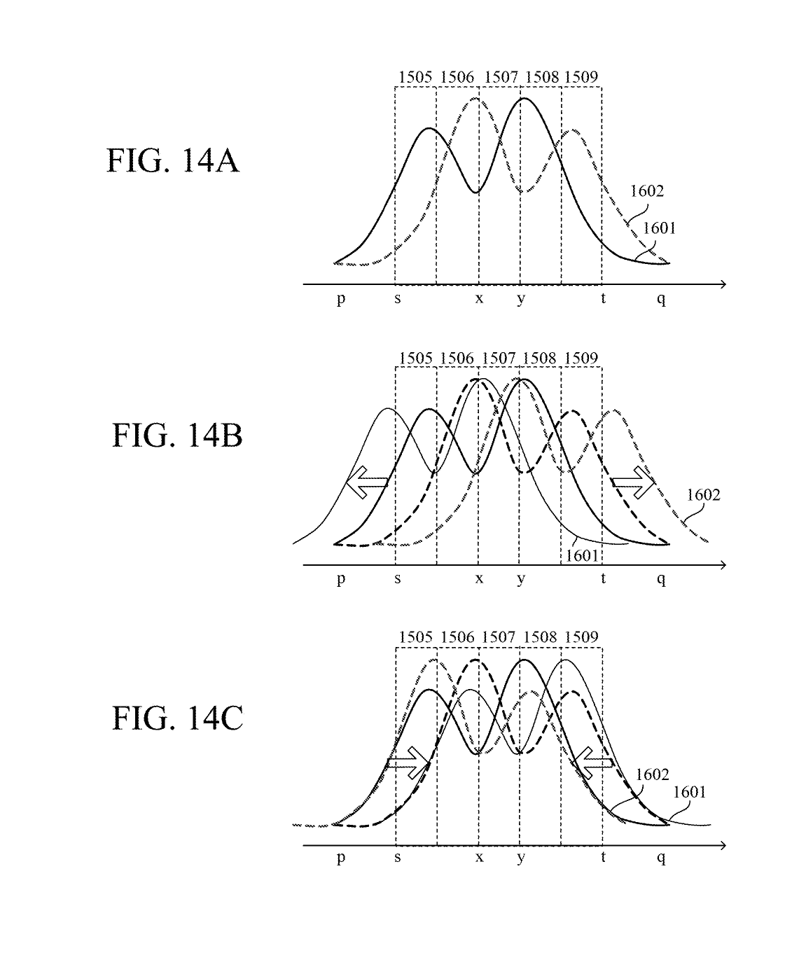

In such a configuration, when it is desired to calculate a shift direction of the correlation calculation in a lateral direction as described below with reference to FIGS. 14A to 14C, the A image signal may be created by adding RA 295 and RC 297 of each microlens, and the B image signal may be created by adding RB 296 and RD 298 of each microlens. Similarly, when it is desired to calculate the shift direction of the correlation calculation in the vertical direction, the A image signal may be created by adding RA 295 and RB 296 of each microlens, and the B image signal may be created by adding the RC 297 and RD 298 of each microlens.

The imaging signal and the AF signal read from the image sensor 201 are input to a CDS/AGC/AD converter 202, and it performs correlated double sampling for removing a reset noise, gain adjustment, and signal digitization. The CDS/AGC/AD converter 202 outputs the imaging signal to the image input controller 203. The image input controller 203 stores the imaging signal output from the CDS/AGC/AD converter 202 in an SDRAM (storage means) 209. Further, the image input controller 203 outputs the AF signal to the AF signal processor 204.

The imaging signal stored in the SDRAM 209 is displayed on a display unit 206 by a display controller 205 via ae bus 21. In the case where the camera body 20 is set to a mode for recording the imaging signal, the imaging signal is recorded on a recording medium 208 by a recording medium controller 207. A ROM 210 is connected via the bus 21 and stores control programs executed by the camera controller 212 and various data necessary for control. A flash ROM 211 stores various pieces of setting information regarding the operation of the camera body 20 such as user setting information, and the like.

The AF signal processor 204 performs pixel addition (pixel combination) and correlation calculation on the AF signal to calculate an image shift amount and reliability information (two image coincidence degree, two image sharpness degree, contrast information, saturation information, scratch information, and the like). The AF signal processor 204 outputs the calculated image shift amount and reliability information to the camera controller 212.

The camera controller 212 notifies the AF signal processor 204 of change of setting for calculating these based on the acquired image shift amount and reliability information. For example, when the image shift amount is large, the camera controller 212 widely sets an area for performing the correlation calculation, or it changes the type of the band pass filter in accordance with the contrast information. The details of the correlation calculation will be described below.

In this embodiment, while a total of three signals of the imaging signal and the two AF signals are taken out from the image sensor 201, the present invention is not limited to this. Considering the load of the image sensor 201, for example, a total of two signals of the imaging signal and the AF signal may be taken out, and the image input controller 203 may acquire the difference between the imaging signal and the AF signal to generate the other AF signal.

The camera controller 212 exchanges information with the whole of the inside of the camera body 20 to perform control. In addition to the processing in the camera body 20, the camera controller 212 performs various camera functions operated by the user, such as switch of on/off of the power supply, change of the setting, start of still or moving image recording, start of the AF control, confirmation of recorded images in accordance with inputs from a camera operator 214. As described above, the camera controller 212 exchanges information with the lens controller 106 in the lens apparatus 10, transmits control command and control information of the lens apparatus 10, and acquires information in the lens apparatus 10.

The camera controller 212 includes a calculator 212a and a controller 212b. The calculator 212a calculates correction information corresponding to the difference between a first signal (first focus detection signal) from the first focus detector and a second signal (second focus detection signal) from the second focus detector. The controller 212b performs focus control based on the first signal in a first area and performs focus control based on the second signal and the correction information in a second area.

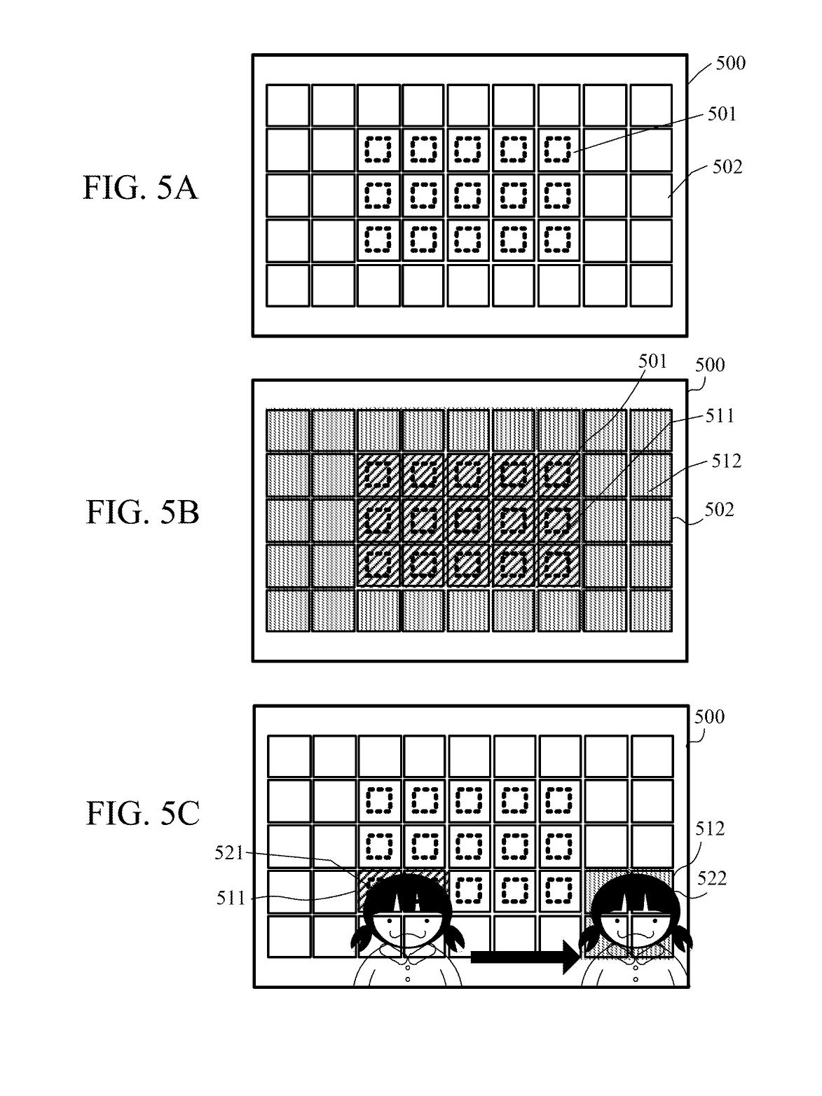

Next, referring to FIGS. 5A to 5C, focus detection areas of the image sensor 201 and the AF sensor 254 in this embodiment will be described. FIGS. 5A to 5C are explanatory diagrams of the focus detection areas.

FIG. 5A illustrates the relationship between an imaging area and frames where focus detection can be performed by using one of the AF sensor 254 and the image sensor 201. Reference numeral 500 denotes a range (imaging area) that can be imaged by the image sensor 201. Reference numeral 501 denotes a frame that can be focused using the AF sensor 254. That is, the AF sensor 254 can perform the focus detection in the area (frame 501) surrounded by 15 squares indicated by a dotted line. Reference numeral 502 denotes a frame where the focus detection can be performed by using the image sensor 201. That is, the image sensor 201 can perform the focus detection in the area (frame 502) surrounded by 45 squares indicated by a solid line.

In this embodiment, the focus detection area (frame 501) of the AF sensor 254 is referred to as the first area, the area that is the focus detection area (frame 502) of the image sensor 201 and that is not the focus detection area (frame 501) of the AF sensor 254 is referred to as the second area.

FIG. 5B illustrates the relationship between the focus detection area of the AF sensor 254 and the focus detection area of the image sensor 201. The dotted and solid squares are the same as those in FIG. 5A. Reference numeral 511 denotes an area (first area, or first focus detection area) where both of the focus detection by the AF sensor 254 and the focus detection by the image sensor 201 can be performed, which is indicated by hatching. Reference numeral 512 denotes an area (second area, or second focus detection area) where the focus detection by the image sensor 201 is possible, but the focus detection by the AF sensor 254 is impossible, which is indicated by vertical lines.

FIG. 5C illustrates the relationship between an object and the focus detection area. The dotted and solid squares are the same as those in FIG. 5A. While the specific procedure of the focus detection in this embodiment will be described below, here, an outline will be described by giving an example.

In this embodiment, first, the focus detection can be performed only when the object exists in the area 511. For example, when an object as illustrated in FIG. SC exists at a position 521, it is possible to perform the focus detection by using the AF sensor 254 in the two frames 501 (area 511) indicated by hatching.

Thereafter, when a still image is captured, the focus detection can be performed by using the image sensor 201 at the same time in two frames 501 (area 511) indicated by hatching. At this time, the difference between the focus detection results of the two AF methods at the position 521 where the object exists is acquired and recorded.

Thereafter, when the object moves from the position 521 to a position 522, the focus detection is performed using the image sensor 201 at the area 512 indicated by the vertical lines (the position 522 where the object exists). At this time, the focus detection is performed by subtracting the difference between the focus detection results of the two AF methods from the focus detection result of the image sensor 201.

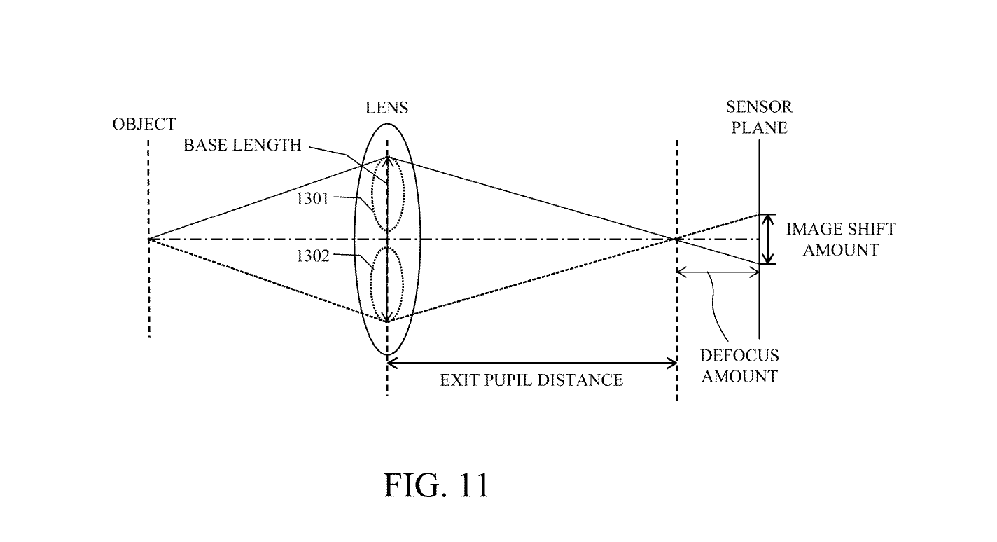

Next, referring to FIGS. 10A to 10F, pixel combination (pixel addition) in this embodiment will be described. FIGS. 10A to 10F are explanatory diagrams of the pixel combination. FIG. 10A, 10B, 10D and 10E illustrate division and addition of the microlenses of the image sensor 201 described with reference to FIGS. 2A to 2C. FIGS. 10C and 10F are examples of the arrangement of the separator lens that will be described with reference to FIGS. 12A to 12C.

In the case of taking a difference in the two AF methods described with reference to FIGS. 5A to 5C, as illustrated in FIG. 2B, in the case where the photodiode is divided in the lateral direction with respect to one microlens, the shift direction of the correlation calculation in the focus detection is also the lateral direction. Therefore, the direction of the separator lens for the focus detection by the corresponding AF sensor 254 for taking the difference is the combination of separator lenses 1031 and 1032 indicated by hatching in FIG. 10C. At this time, the shift directions of the correlation calculations of the two AF methods coincide with each other, so that a closer object is being viewed.

In the case where in a configuration having four photodiodes for one microlens as illustrated in FIG. 2C (=FIG. 10A), the addition is performed as illustrated in FIG. 10B to shift the correlation calculation in the lateral direction will be considered. At this time, the AF sensor 254 which performs the correlation calculation by combining the hatched separator lenses 1031 and 1032 in FIG. 10C is combined. As a result, similarly, the shift directions of the correlation calculations by the two AF methods coincide with each other.

In the case where in a configuration having four photodiodes for one microlens as illustrated in FIG. 2C (=FIG. 10D), the addition is performed as illustrated in FIG. 10E to shift the correlation calculation in the vertical direction will be considered. At this time, the AF sensor 254 which performs the correlation calculation by combining the hatched separator lenses 1061 and 1062 in FIG. 10F is combined. As a result, similarly, the shift directions of the correlation calculations by the two AF methods coincide with each other.

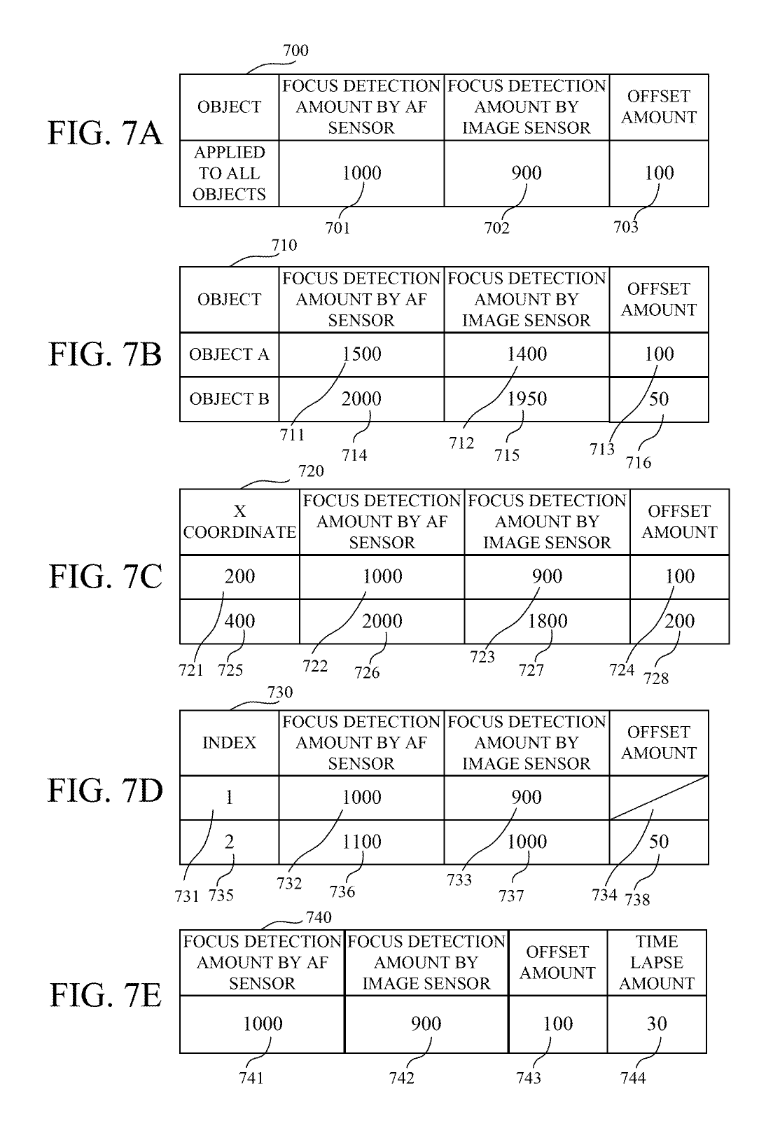

Next, referring to FIG. 7A, an offset information table in this embodiment will be described. FIG. 7A is an explanatory diagram of the offset information table. The offset information table (offset information 700) is stored in the SDRAM 209, for example. The offset information 700 includes a focus detection amount 701 by the AF sensor 254, a focus detection amount 702 by the image sensor 201, and an offset amount 703. The method of calculating these amounts will be described below.

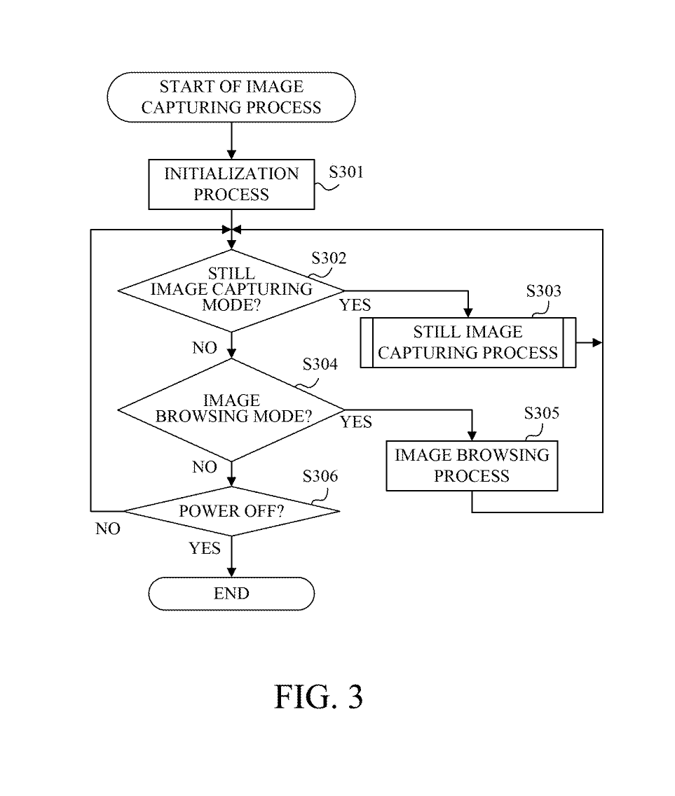

Next, referring to FIG. 3, the operation of the image capturing apparatus 1 (camera body 20) will be described. FIG. 3 is a flowchart illustrating the procedure of the image capturing process of the camera body 20. Each step of FIG. 3 is mainly performed based on a command from the camera controller 212 of the camera body 20.

First, in step S301, the camera controller 212 performs an initialization process of the camera body 20. Subsequently, in step S302, the camera controller 212 determines whether a still image capturing mode is set by the user operating the camera operator 214. When the camera body 20 is set to the still image capturing mode, the process proceeds to step S303. On the other hand, when the camera body 20 is not set to the still image capturing mode, the process proceeds to step S304.

In step S303, the camera controller 212 performs a still image capturing process and returns to step S302. The details of the still image capturing process will be described below. In step S304, the camera controller 212 determines whether an image browsing mode is set by the user operating the camera operator 214. When the camera body 20 is set to the image browsing mode, the process proceeds to step S305. On the other hand, when the camera body 20 is not set to the image browsing mode, the process proceeds to step S306.

In step S305, the camera controller 212 performs an image browsing process, and after the image browsing process is completed, the process returns to step S302. The image browsing process is a process of displaying an image, and a known method can be used, so a detailed description thereof will be omitted. In step S306, the camera controller 212 determines whether the user instructs the camera operator 214 to turn off the power of the camera body 20 (i.e., whether the power supply of the camera body 20 is turned off). When the power supply of the camera body 20 is not off, the process returns to step S302. On the other hand, when the power source of the camera body 20 is turned off, this process is terminated.

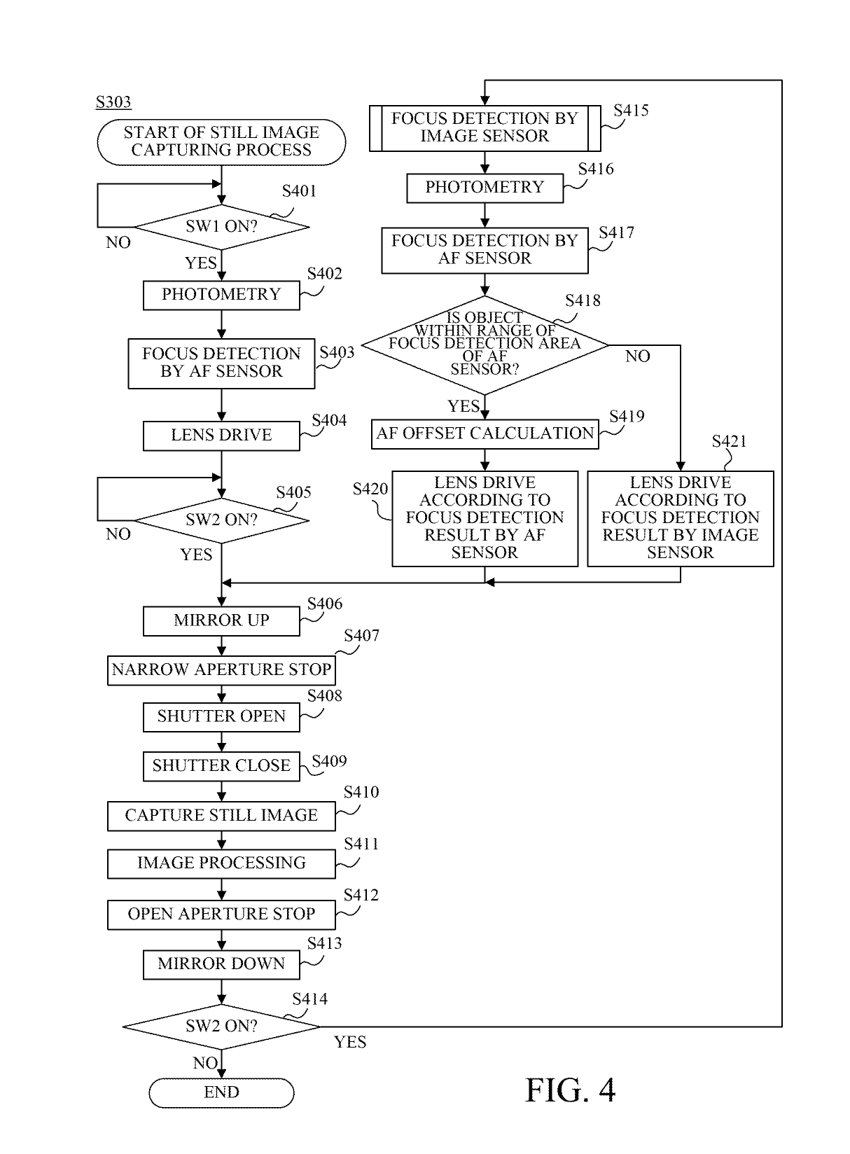

Next, referring to FIG. 4, step S303 (still image capturing process) in FIG. 3 will be described. Each step of FIG. 4 is mainly performed based on a command from the camera controller 212. In this embodiment, in the still image capturing process, when the shutter of the camera operator 214 of the camera body 20 is half-pressed (SW1), the AF operation is started. When the shutter is fully pressed (SW2), still image capturing is started. While the shutter is fully pressed (SW2), still images are continuously captured (i.e., continuous shooting is performed) always. The camera controller 212 performs the focus detection by the AF sensor 254 and the focus detection by the image sensor 201 even during the continuous shooting, and it can follow the object even if the object moves.

First, in step S401, the camera controller 212 determines whether the half-press (SW1) of the shutter of the camera operator 214 is turned on (i.e., whether the shutter is half-pressed). When SW1 is turned on, the process proceeds to step S301. On the other hand, when SW1 is not ON, step S401 is repeated until SW1 is turned ON. In step S402, the camera controller 212 measures the light beam that has passed through the lens apparatus 10 and reflected by the main mirror (quick return mirror 252) and passed through the pentaprism 251 by using a photometric circuit (not illustrated). Subsequently, in step S403, the camera controller 212 performs the focus detection by using the AF sensor 254 and the focus detection circuit 255. Details of the focus detection by the AF sensor 254 will be described below.

Subsequently, in step S404, the camera controller 212 transmits a lens drive amount to the lens controller 106 based on the focus detection result obtained in step S403. The lens controller 106 controls the focus lens driver 105 so as to drive the focus lens 103 to an in-focus position based on the lens drive amount transmitted from the camera controller 212.

Subsequently, in step S405, the camera controller 212 determines whether the full-press (SW2) of the shutter of the camera operator 214 is turned on (i.e., whether the shutter is fully pressed). When SW2 is turned on, the process proceeds to step S406. On the other hand, when SW2 is not ON, step S405 is repeated until SW2 is turned ON.

In step S406, the camera controller 212 controls the quick return mirror 252 to perform mirror up. Subsequently, in step S407, the camera controller 212 transmits aperture value information set in step S402 to the lens controller 106. Based on the aperture value information transmitted from the camera controller 212, the lens controller 106 drives the aperture driver 104 to narrow down to the set aperture value (F number).

Subsequently, in step S408, the camera controller 212 performs control to open the focal plane shutter 258. After a lapse of a predetermined time, in step S409, the camera controller 212 closes the focal plane shutter 258. Then, the camera controller 212 performs a charge operation of the focal plane shutter 258 in preparation for the next operation.

Subsequently, in step S410, the camera controller 212 reads image data of the image sensor 201 (i.e., captures a still image) to the image input controller 203. In this embodiment, the camera controller 212 reads the A image, the B image, and the A+B image described with reference to FIGS. 2A to 2C as image data. Subsequently, in step S411, the camera controller 212 controls the image input controller 203 to perform image processing such as compression (image compression) and the like on the image data captured from the image sensor 201, and it records the image data in the recording medium 208.

Subsequently, in step S412, the camera controller 212 instructs the lens controller 106 to open the aperture stop 102. Then, the lens controller 106 drives the aperture driver 104 to open the aperture stop 102. Subsequently, in step S413, the camera controller 212 drives the quick return mirror 252 down.

Subsequently, in step S413, the camera controller 212 determines whether the full-press (SW2) of the shutter of the camera operator 214 is continued (i.e., whether the switch SW2 remains on). When SW2 remains on, the process proceeds to step S415. On the other hand, when SW2 is not on, the camera controller 212 determines that subsequent still image capturing is not instructed, and it terminates this process.

In step S415, the camera controller 212 performs the focus detection by the image sensor 201 using the A image and the B image among the still images read out in step S410. Then, the camera controller 212 stores a focus detection amount (focus detection result) in the SDRAM 209 as offset information 700 (focus detection amount 702 by the image sensor 201). Details of the focus detection method by the image sensor 201 will be described below.

Subsequently, in step S416, similarly to step S402, the camera controller 212 performs the photometry again using the photometric circuit (not illustrated). Subsequently, in step S417, similarly to step S403, the camera controller 212 performs the focus detection by the AF sensor 254. Then, the camera controller 212 stores the focus detection amount (focus detection result) in the SDRAM 209 as offset information 700 (focus detection amount 701 by the AF sensor 254).

Subsequently, in step S418, the camera controller 212 determines whether the object exists within a range in which the focus detection can be performed by the AF sensor 254 (within the range of the focus detection area of the AF sensor 254, that is, within the range of the first area). When the object does not exist within the range of the focus detection area of the AF sensor 254, the process proceeds to step S421. At this time, the focus detection amount 701 by the AF sensor 254 is not stored in the SDRAM 209. Details of the focus detection by the AF sensor 254 will be described below.

On the other hand, when the object exists within the range of the focus detection area of the AF sensor 254 in step S418, the process proceeds to step S419. In step S419, the camera controller 212 calculates, as an offset amount 703 (AF offset), information on how much the focus detection amount 702 by the image sensor 201 deviates from the focus detection amount 701 by the AF sensor 254. Then, the camera controller 212 stores the calculated offset amount 703 in the SDRAM 209. The offset amount 703 is correction information corresponding to the difference between the focus detection signal from the AF sensor 254 and the focus detection signal from the image sensor 201, and for example it is calculated as follows.

Current focus detection amount 701 by the AF sensor: DA=1000

Current focus detection amount 702 by the image sensor: DD=900

Offset amount 703: Of

Of=DA−DD (1)

In the example of FIG. 7A, when a specific numerical value is substituted in expression (1), expression (2) below is obtained.

1000−900=100 (2)

That is, 100 is substituted as the offset amount 703.

Subsequently, in step S420, the camera controller 212 drives the focus lens 103 to the in-focus position based on the focus detection result by the AF sensor 254 in step S417, and then the process returns to step S406.

In step S421, the camera controller 212 drives the focus lens 103 to the in-focus position based on a value obtained by adding the offset amount 703 to the focus detection amount 702 by the image sensor 201 of the offset information 700, and then the process returns to step S406. In this embodiment, the drive amount (lens drive amount) of the focus lens 103 at this time is represented by expression (3) below

Current focus detection amount 702 by the image sensor: DD=900

Offset amount 703: Of

Lens drive amount: F

F=DD+Of (3)

In the example of FIG. 7A, when specific numerical values are substituted in expression (3), expression (4) below is obtained.

900+100=1000 (4)

That is, the focus lens 103 is driven by the lens drive amount F=1000.

Next, referring to FIGS. 12A to 12C, the principle of focus detection and defocus amount detection (detection of a shift amount of a focus position) by the AF sensor 254 will be described. FIGS. 12A to 12C are explanatory diagrams of the focus detection of the phase difference method by the AF sensor 254.

FIGS. 12A and 12B are explanatory diagrams of the principle of the detection of the defocus amount. As illustrated in FIGS. 12A and 12B, when the image sensor 201 is in focus (in an in-focus state), the interval between two images on a line sensor indicates a certain value. Although this value can be obtained by design, in reality, it is not the same value as the design value due to the dimensions and variations of the parts and assembly error. Accordingly, it is difficult to obtain the two image intervals (reference two-image interval Lo) unless measurement is actually performed. As illustrated in FIG. 12A, if the interval between the two images is narrower than the reference two-image interval Lo, it is in a front focus state, and on the other hand, if it is wider than the reference two-image interval Lo, it is in a rear focus state.

FIG. 12B is a diagram illustrating a model in which the condenser lens is omitted from the optical system of the AF sensor module (not illustrated). As illustrated in FIG. 12B, assuming that the angle of the principal ray is θ, the magnification of the separator lens is β, and moving amounts of the image is ΔL and ΔL′, a defocus amount L is calculated by expression (5) below.

$$d = \frac{Δ L}{tan θ} = \frac{Δ {L}^{′}}{β \cdot tan θ} \qquad ( 5 )$$

In expression (5), symbol βtan θ is a parameter determined by the design of the AF sensor module. Symbol ΔL′ can be obtained based on the reference two-image interval Lo and a current two-image interval Lt. Actually, the image of the light receiving element illustrated in FIG. 12A corresponds to 1601 and 1602 in FIGS. 14A to 14C in the focus detection by the image sensor 201 described above, and a correlation amount COR is calculated by the same calculation. Based on that, a focus amount is calculated similarly to the focus detection by the image sensor 201 described above. The AF sensor 254 includes a plurality of the above-described structures so that the focus detection can be performed at a plurality of positions on the image plane.

Further, as illustrated in FIG. 12C, when two separator lenses 1421 and 1422 are arranged in a lateral direction of the light receiving element, the correlation calculation can be shifted in the lateral direction, and it is possible to perform the focus detection of an object having the lateral contrast. On the other hand, when separator lenses 1423 and 1424 are arranged in a vertical direction of the light receiving element, the correlation calculation can be shifted in the vertical direction.

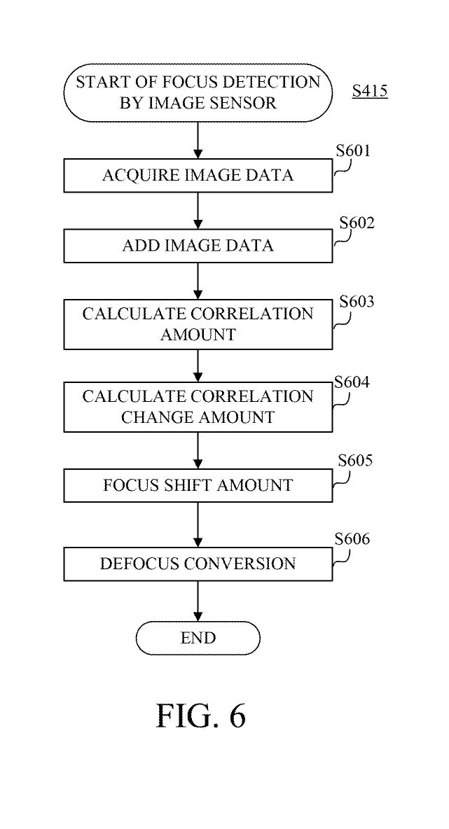

Next, referring to FIG. 6, a focus detection process (imaging plane phase difference AF) by the image sensor 201 will be described in detail. FIG. 6 is a flowchart illustrating the focus detection process by the image sensor 201, which corresponds to step S415 in FIG. 4. Each step of FIG. 6 is mainly performed by the camera controller 212, or by the image sensor 201 or the AF signal processor 204 based on a command from the camera controller 212.

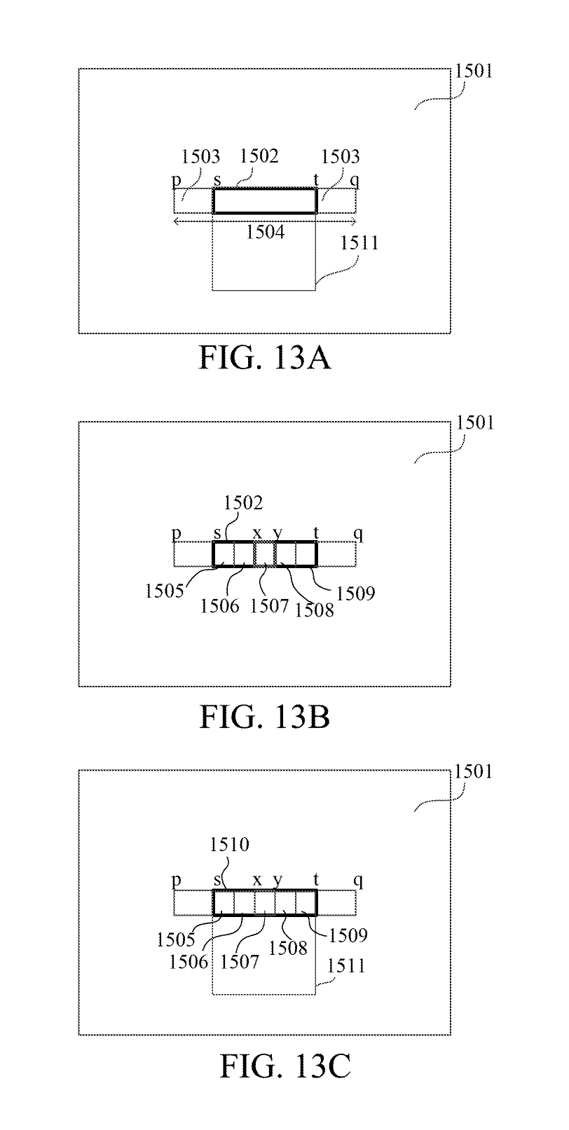

First, in step S601, the camera controller 212 acquires an image signal from a focus detection range arbitrarily set by the user. The acquisition of the image signal will be described below with reference to FIGS. 13A to 13C. Subsequently, in step S602, the camera controller 212 adds (combines) the image signals acquired in step S601. The addition (combination) of the image signals will be described below with reference to FIGS. 13A to 13C.

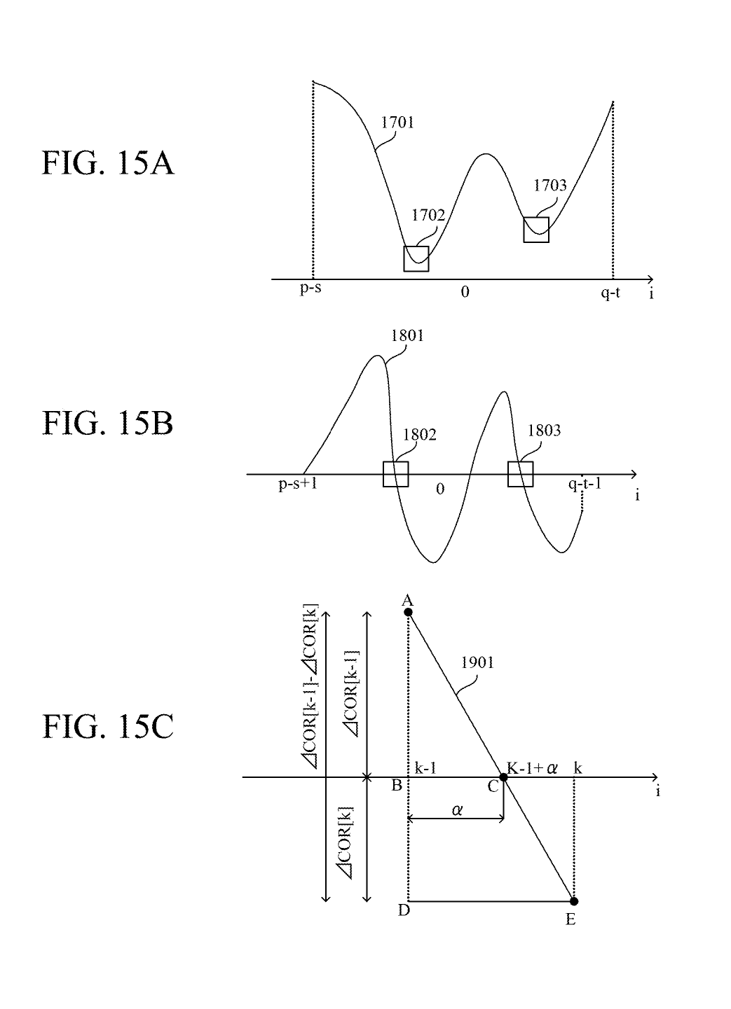

Subsequently, in step S603, the camera controller 212 calculates the correlation amount based on the image signal added (combined) in step S602. The calculation of the correlation amount will be described below with reference to FIGS. 14A to 14C. Subsequently, in step S604, the camera controller 212 calculates a correlation change amount based on the correlation amount calculated in step S603. The calculation of the correlation change amount will be described below with reference to FIGS. 15A to 15C.

Subsequently, in step S605, the camera controller 212 calculates a focus shift amount (image shift amount) based on the correlation change amount calculated in step S604. Calculation of the focus shift amount will be described below with reference to FIGS. 15A to 15C. The camera controller 212 performs the above process for each focus detection area (by the number of the focus detection areas). Subsequently, in step S606, the camera controller 212 converts the focus shift amount calculated for each focus detection area into a defocus amount, and it terminates the focus detection process in FIG. 6.

Next, referring to FIGS. 13A to 13C, the focus detection area of the image sensor 201 will be described. FIGS. 13A to 13C illustrate an example of the focus detection area (area for acquiring an image signal indicating a focus detectable range). FIG. 13A is a diagram illustrating the focus detection area on the pixel array of the image sensor 201. Reference numeral 1501 denotes a pixel array, reference numeral 1502 denotes a focus detection area (focus detection range), and reference numeral 1503 denotes a shift area necessary for the correlation calculation. Reference numeral 1504 denotes an area obtained by combining the focus detection area 1502 and the shift area 1503, which is an area necessary for performing the correlation calculation.

Symbols p, q, s, and t in FIG. 13A represent the coordinates in an x-axis direction, symbols p to q represent the range of the area 1504, and symbols s to t represent the range of the focus detection area 1502. For easy description of each of the heights of the focus detection area 1502 and the shift area 1503, they are described by one line. When the focus detection of the area for a plurality of lines like the focus detection area 1511, the focus detection is performed after pixels are vertically added in advance. The addition of the correlation amount will be described below

FIG. 13B illustrates a state in which the focus detection area 1502 is divided into five areas. In this embodiment, as an example, a focus shift amount is calculated for each focus detection area (by a focus detection area unit) and the focus detection is performed. Each of the focus detection areas 1505 to 1509 is one focus detection area obtained by dividing the focus detection area 1502 into five. In this embodiment, as an example, a signal (focus detection result) obtained from the most reliable focus detection area out of the plurality of divided focus detection areas is selected, and the calculated focus shift amount calculated based on a signal obtained from the focus detection area is used.

FIG. 13C is a diagram illustrating a provisional focus detection area 1510 obtained by connecting the focus detection areas 1505 to 1509 in FIG. 13B. In this embodiment, as an example, the focus shift amount calculated from the focus detection area 1510 obtained by connecting the plurality of focus detection areas 1505 to 1509 may be used. The arrangement of the focus detection areas, the size of the focus detection area, and the like are not limited to the configurations described in this embodiment, and other configurations may be adopted.

Next, referring to FIGS. 14A to 14C, image signals acquired from the focus detection areas set as illustrated in FIGS. 13A to 13C will be described. FIGS. 14A to 14C are explanatory diagrams of the image signals acquired from the focus detection areas. In FIGS. 14A to 14C, symbols s to t represent focus detection ranges, and symbols p to q are ranges required for focus detection calculation in consideration of the shift amount. Symbols x to y represent one focus detection area among the divided focus detection areas.

FIG. 14A is a waveform diagram of an image signal before shifting. A solid line 1601 is an image signal A, and a dashed line 1602 is an image signal B. Reference numerals 1505 to 1509 represent a plurality of divided focus detection areas as illustrated in FIG. 13B. FIG. 14B is a waveform diagram shifted in a plus direction with respect to the waveform of the image signal before shifting as illustrated in FIG. 14A. FIG. 14C is a waveform diagram shifted in a minus direction with respect to the waveform of the image signal before shifting as illustrated in FIG. 14A. In calculating the correlation amount, each of the solid lines 1601 and 1602 is shifted by one bit in the direction of an arrow.

Next, a method of calculating the correlation amount COR will be described. First, as described with reference to FIGS. 14B and 14C, the image signal A and the image signal B are shifted bit by bit, and the sum of an absolute value of the difference between the image signal A and the image signal B at that time is calculated. At this time, the shift amount is represented by i, the minimum shift number is p-s in FIGS. 14A to 14C, and the maximum shift number is q-t in FIGS. 14A to 14C. Symbol x is the start coordinate of the focus detection area, and symbol y is the end coordinate of the focus detection area. The correlation amount COR[i] can be calculated using them as represented by expression (6) below.

$$COR [ i ] {\sum }_{k = x}^{y} \vert A [ K + i ] - B [ K - i ] \vert \\ \{ ( p - s ) < i < ( q - t ) \} \qquad ( 6 )$$

Pixels may be added in the vertical direction as described above. Alternatively, assuming that the correlation amount COR[i] is calculated for the focus detection area 1510 in FIG. 13C, if the area where the focus detection is actually to be performed is the focus detection area 1511, after the correlation amount COR[i] is calculated for each line and they are added, the process may be moved to the following process.

Next, referring to FIGS. 15A to 15C, the correlation amount COR[i] in the focus detection process will be described. FIGS. 15A to 15C are explanatory diagrams of the correlation amount COR[i]. FIG. 15A is a waveform diagram of the correlation amount. In FIG. 15A, the horizontal axis represents the shift amount and the vertical axis represents the correlation amount. Reference numeral 1701 denotes a correlation amount waveform, and reference numerals 1702 and 1703 denote areas around an extreme value. Among them, the smaller the correlation amount is, the higher the degree of coincidence between the A image and the B image is.

Next, a method of calculating the correlation change amount ΔCOR will be described. First, using the correlation amount waveform of FIG. 15A, the correlation change amount is calculated based on the difference of the correlation amount of two shifts. At this time, the shift amount is represented by i, the minimum shift number is p-s in FIGS. 14A to 14C, and the maximum shift number is q-t in FIGS. 14A to 14C. The correlation change amount ΔCOR[i] can be calculated using them as represented by expression (7) below.

ΔCOR[i]=COR[i−1]−COR[i+1]

{(p−s−1)<i<(q−t−1)} (7)

FIG. 15B is a waveform diagram of the correlation change amount ΔCOR. In FIG. 15B, the horizontal axis represents the shift amount and the vertical axis represents the correlation change amount. Reference numeral 1801 is a correlation change amount waveform, and reference numerals 1802 and 1803 are areas where the correlation change amount becomes positive to negative. When the correlation change amount becomes 0, it is called zero crossing, the degree of coincidence between the A image and the B image is the highest, and the shift amount at that time is the focus shift amount.

FIG. 15C is an enlarged view of the area 1802 of FIG. 15B. Reference numeral 1901 denotes a part of the correlation change amount waveform 1801. Here, a method of calculating the focus shift amount PRD will be described. First, the focus shift amount is divided into an integer part β and a decimal part α. Based on the similarity relationship between the triangle ABC and the triangle ADE in FIG. 15C, the decimal part a can be calculated by expression (8) below.

$$AB \text{:} AD = BC \text{:} DE \\ Δ COR [ K - 1 ] = Δ COR [ k - 1 ] - Δ COR [ k ] = α \text{:} k - ( k - 1 ) \\ α = \frac{Δ COR [ K - 1 ]}{Δ COR [ K - 1 ] - Δ COR [ K ]} \qquad ( 8 )$$

Subsequently, the integer part 13 can be calculated from expression (9) below from FIG. 15C.

βk−1 (9)

That is, the focus shift amount PRD can be calculated from the sum of the decimal part a and the integer part β. Actually, it is necessary to multiply the focus shift amount PRD by a coefficient K for actually calculating a lens drive amount to be converted into the defocus amount.

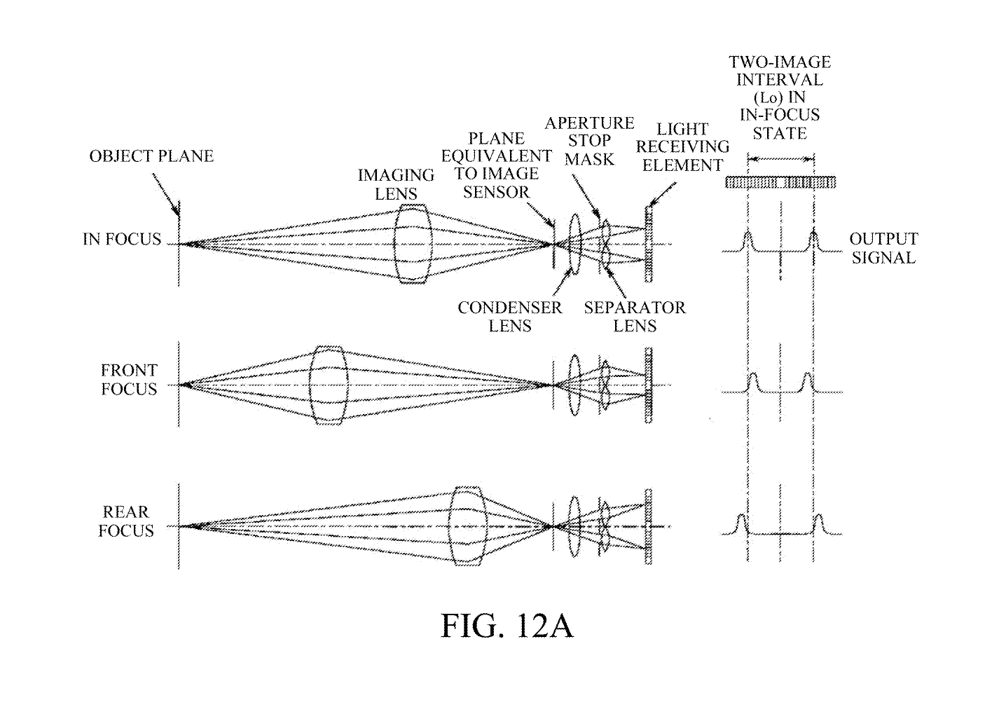

Here, referring to FIG. 11, a method of calculating the coefficient K will be described. FIG. 11 is a diagram illustrating the positional relationship between the object, the lens (image capturing optical system) of the lens apparatus 10, and the image sensor 201. While the shapes of the pupils 1301 and 1302 are changed in the focus detection by both the AF sensor 254 and the image sensor 201, the method of calculating the coefficient K is the same. In FIG. 11, while one convex lens is illustrated as an image capturing optical system, actually, the lens apparatus 10 only needs to have one or more lenses.

The exit pupil distance A is a value unique to the lens. The base length B is a length (length combined with the pupils 301 and 302) of the pixel A (for example, reference numeral 201 in FIG. 2A) of the image sensor 201 and the pixel B (for example, reference numeral 205 in FIG. 2A) projected on the lens. The image shift amount C (focus shift amount PRD) is the amount illustrated in FIG. 14A. At this time, the defocus amount D can be calculated from the similarity relationship of the two triangles as represented by expression (10) below.

D=A/B*C (10)

Further, the coefficient K can be calculated by expression (11) below.

K=A/B (11)

By multiplying the image shift amount (focus shift amount PRD) by the coefficient K, the defocus amount D can be calculated.

According to this embodiment, by adding the offset amount, it is possible to reduce the stepped operation and the hunting operation due to the difference between the focus detection results by the two AF methods. Further, according to this embodiment, it is possible to reduce these operations with a small calculation amount without storing a large capacity table, as in steps S419 and S420, for example.

### Second Embodiment

Next, a second embodiment of the present invention will be described. This embodiment is the same as the first embodiment except for the offset information and the still image capturing process flow. The offset information of this embodiment has different offset amounts for each object. This is because the spatial frequency, color, contrast, and the like of the object are unique to the object, and the offset amount is also unique to the object.

Referring to FIG. 7B, an offset information table in this embodiment will be described. FIG. 7B is an explanatory diagram of the offset information table. The offset information table (offset information 710) is stored in the SDRAM 209 for each object, for example. Although the example of FIG. 7B illustrates two objects, this embodiment can also be applied to the case where three or more objects exist.

The offset information of an object A (first object) includes a focus detection amount 711 by the AF sensor 254, a focus detection amount 712 by the image sensor 201, and an offset amount 713. The offset information of an object B (second object) includes a focus detection amount 714 by the AF sensor 254, a focus detection amount 715 by the image sensor 201, and an offset amount 716. Methods of calculating them will be described below.

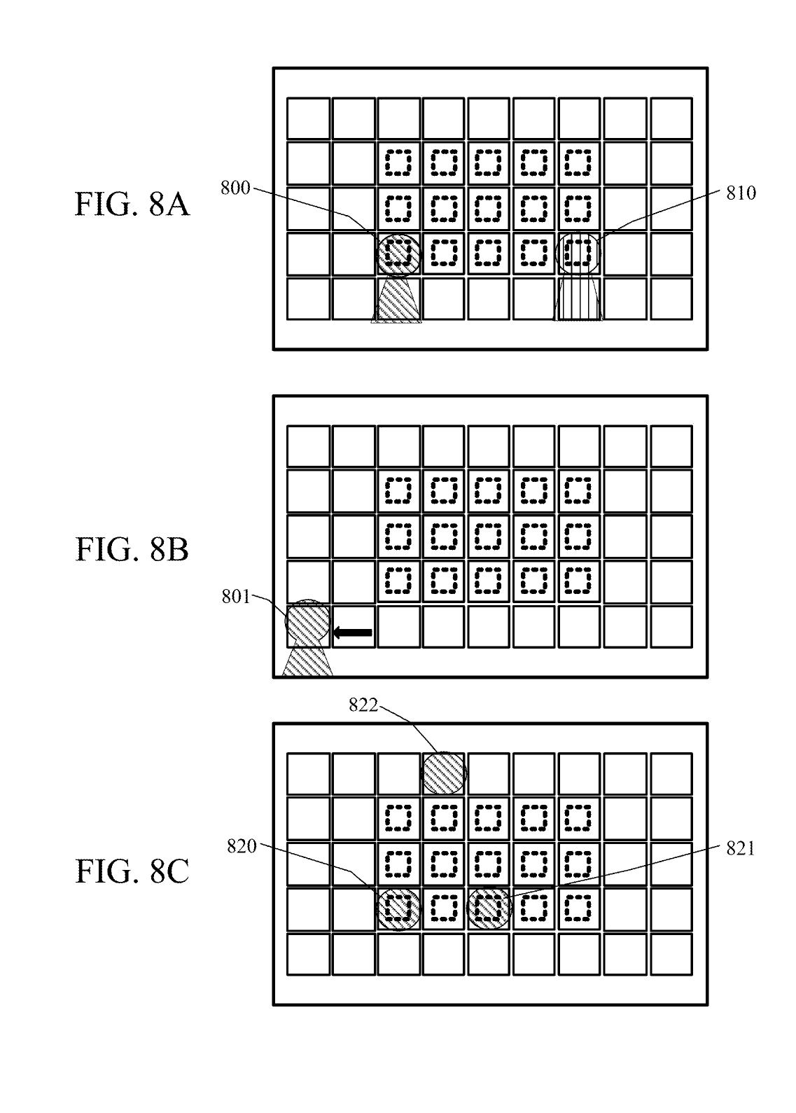

FIG. 8A illustrates an example in the case where two objects exist within a range of the focus detection area of the image sensor 201. The dotted and solid squares are the same as in FIG. 5A. As illustrated in FIG. 8A, the object A indicated by hatching in a frame 800 and the object B indicated by a vertical line in a frame 810 exist.

Next, a still image capturing process flow of FIG. 4 in the case where the two objects A and B exist as illustrated in FIG. 8A will be described. Here, only processes different from those in the first embodiment will be described.

In step S401, the user turns on (presses halfway) SW1 to place the object in the viewfinder in order to capture a still image, and then, in step S405, SW2 is turned on (fully pressed) to start continuous still image capturing. When SW2 is kept on (fully pressed) in step S414, it is assumed that the object exists in each of the frame 800 and the frame 810 when performing focus detection by the image sensor 201 in step S415. At that time, the objects A and B are imaged by the image sensor 201, and the camera controller 212 recognizes that the objects A and B exist in the captured image. Then, the camera controller 212 prepares a table for two people as offset information 710 as illustrated in FIG. 7B.

Further, the camera controller 212 records the focus detection amount by the image sensor 201 in the frame where the object A exists, as the focus detection amount 712 by the image sensor 201. Similarly, the camera controller 212 records the focus detection amount by the image sensor 201 in the frame where the object B exists, as the focus detection amount 715 by the image sensor 201.

Subsequently, in step S417, the camera controller 212 records the focus detection amount by the AF sensor 254 of the frame 800 where the object A exists, as the focus detection amount 711 by the AF sensor 254. Similarly, the camera controller 212 records the focus detection amount by the AF sensor 254 of the frame 810 where the object B exists, as the focus detection amount 714 by the AF sensor 254.

Subsequently, in step S418, since the objects A and B exist in the frames 800 and 810, respectively, and are within the range of the focus detection area of the AF sensor 254, the process proceeds to step S419. In step S419, the camera controller 212 calculates and records the offset amount 713 of the object A from the offset information 710 based on the focus detection amount 711 by the AF sensor 254 and the focus detection amount 712 by the image sensor 201. Similarly, the camera controller 212 calculates and records the offset amount 716 of the object B based on the focus detection amount 714 by the AF sensor 254 and the focus detection amount 715 by the image sensor 201. The methods of calculating them are the same as those in expression (1).

After repeating the still image capturing process, as illustrated in FIG. 8B, it is assumed that the object B moves out of the screen and only the object A remains in the screen, but the object A has moved to the position of the frame 801. In step S415, when performing the focus detection by the image sensor 201, the object A is imaged by the image sensor 201, and the camera controller 212 recognizes the object A. In addition, the camera controller 212 recognizes that the object A is the same person as the object A already recorded in the offset information 710. Therefore, the camera controller 212 records the focus detection amount by the image sensor 201 of the frame 801 where the object A exists, as the focus detection amount 712 by the image sensor 201.

Subsequently, in step S417, the object does not exist within the range of the AF sensor 254, so the camera controller 212 does not store the focus detection result. Subsequently, in step S418, since the object A exists outside the range of the focus detection area of the AF sensor 254, the process proceeds to step S421. In step S421, the camera controller 212 drives the focus lens 103 to the in-focus position based on a value obtained by adding the offset amount 713 calculated and stored in the previous step S419, which is not the present time, to the focus detection amount 702 for the object A in step S415. Then, the process proceeds to step S406.

According to this embodiment, by adding the offset amount for each object, it is possible to reduce the stepped operation and the hunting operation due to the difference between the focus detection results by the two AF methods. Further, according to this embodiment, it is possible to reduce these operations with a small calculation amount without storing a large capacity table, as in steps S419 and S420, for example.

### Third Embodiment

Next, a third embodiment of the present invention will be described. This embodiment is the same as the first embodiment except for the offset information and the still image capturing process flow. The offset information of this embodiment has different offset amount for each position such as an X coordinate. This is because in the imaging plane phase difference AF using the image sensor having the configuration illustrated in FIG. 2B, while the change of the ratio between the A image and the B image of the pupil is small when the coordinate in the vertical direction changes the change of the ratio between the A image and the B image of the pupil is large when the coordinate in the horizontal direction changes.

Referring to FIG. 7C, an offset information table in this embodiment will be described. FIG. 7C is an explanatory diagram of the offset information table. The offset information table (offset information 720) is stored in the SDRAM 209 for each X coordinate (position), for example. In the example of FIG. 7C, since the process of step S419, which will be described below, has been performed twice, two pieces of offset information are stored. Every time the process of step S419 is performed, the offset information increases. The offset information of a first process in step S419 includes a focus detection amount 722 by the AF sensor 254 in the X coordinate 721, a focus detection amount 723 by the image sensor 201, and an offset amount 724. The offset information of a second process in step S419 includes a focus detection amount 726 by the AF sensor 254 in the X coordinate 725, a focus detection amount 727 by the image sensor 201, and an offset amount 728. The number of X coordinates may be infinitely increased, or the upper limit may be determined and the table may be reused by looping.

FIG. 8C illustrates an example in the case where a shaded round object in the image sensor 201 moves to a frame 822. The dotted and solid squares in FIG. 8C are the same as in FIG. 5A.

Next, the still image capturing process flow of FIG. 4 in the case where the shaded round object illustrated in FIG. 8C exists will be described. Here, only processes different from those in the first embodiment will be described.

In step S401, the user turns on (presses halfway) SW1 to place the object in the viewfinder in order to capture a still image, and then, in step S405, SW2 is turned on (fully pressed) to start continuous still image capturing. When SW2 is kept on (fully pressed) in step S414, it is assumed that the round object indicated by hatching exists in a frame 820 when performing the focus detection by the image sensor 201 in step S415. Then, the camera controller 212 temporarily stores the focus detection amount by the image sensor 201 of the frame 820.

In step S417, the camera controller 212 temporarily stores the focus detection amount by the AF sensor 254 of the frame 820 where the round object exists. Subsequently, in step S418, since the round object exists in the frame 820, it exists within the range of the focus detection area of the AF sensor 254. Therefore, the process proceeds to step S419.

Subsequently, in step S419, the camera controller 212 newly ensures an area for one line for the offset information. This area corresponds to the X coordinate 721, the focus detection amount 722 by the AF sensor 254, the focus detection amount 723 by the image sensor 201, and the offset amount 724 in FIG. 7C. Then, the camera controller 212 records the X coordinate 721 of the round object, the focus detection amount 722 temporarily stored in step S417, and the focus detection amount 723 temporarily stored in step S415 in the SDRAM 209. Then, the camera controller 212 records the offset amount 724 calculated based on the focus detection amount 722 and the focus detection amount 723 in the SDRAM 209. The methods of calculating them are the same as those in expression (1).

Then, if SW2 remains on (fully pressed) in step S414, it is assumed that the round object exists in the frame 821 when performing the focus detection by the image sensor 201 in step S415. At this time, the camera controller 212 temporarily stores the focus detection amount by the image sensor 201 of the frame 821. In step S417, the camera controller 212 temporarily stores the focus detection amount by the AF sensor 254 of the frame 821 where the round object exists. In step S418, since the round object exists in the frame 821, it is within the range of the focus detection area by the AF sensor 254. Therefore, the process proceeds to step S419.

In step S419, the camera controller 212 newly ensures an area for one row for the offset information. This area corresponds to the X coordinate 725, the focus detection amount 726 by the AF sensor 254, the focus detection amount 727 by the image sensor 201, and the offset amount 728 in FIG. 7C. Then, the camera controller 212 records the X coordinate 725 of the round object, the focus detection amount 726 temporarily stored in step S417, and the focus detection amount 727 temporarily stored in step S415 in the SDRAM 209. Then, the camera controller 212 records the offset amount 728 calculated based on the focus detection amount 726 and the focus detection amount 727 in the SDRAM 209. The methods of calculating them are the same as those in expression (1).

Then, if SW2 remains on (fully pressed) in step S414, it is assumed that the round object exists in the frame 822 when performing the focus detection by the image sensor 201 in step S415. At this time, the camera controller 212 temporarily stores the focus detection amount by the image sensor 201 of the frame 822. In step S417, since the frame 822 where the round object exists is outside the range of the focus detection area of the AF sensor 254. the camera controller 212 does not store the focus detection amount by the AF sensor 254. In step S418, since the round object exists in the frame 822, it is outside the range of the focus detection area of the AF sensor 254. Therefore, the process proceeds to step S421.

In step S421, the camera controller 212 adds an offset to the focus detection amount by the image sensor 201 temporarily stored in step S415 to drive the lens. Here, the X coordinate of the frame 822 is set to X=300. Since the same X coordinate does not exist in the offset information 720, interpolation calculation is performed as follows.

First X coordinate 721 in step 419 : X0=200

First offset amount 724 in step S419: Of0=100

Second X coordinate 725 in step S419: X1=400

Second offset amount 728 in step S419: Of1=200

Obtained offset amount Of

Of=0+(Of1−Of0)(X−X0)/(X1−X0) (12)

In this case, when specific numerical values are substituted in expression (12), expression (13) below is obtained.

100+(200−100)(300−200)/(400−200)=150 (13)

In this way, the camera controller 212 adds the offset amount Of=150 to the focus detection amount by the image sensor 201 temporarily stored in step S415, and drives the focus lens 103 to the in-focus position. Then, the process proceeds to step S406.

According to this embodiment, by adding the offset amount for each position such as the X coordinate, it is possible to reduce the stepped operation and the hunting operation due to the difference between the focus detection results by the two AF methods. Further, according to this embodiment, it is possible to reduce these operations with a small calculation amount without storing a large capacity table, as in steps S419 and S420, for example.

### Fourth Embodiment

Next, a fourth embodiment of the present invention will be described. This embodiment is the same as the first embodiment except for the offset information and the still image capturing process flow. In this embodiment, the focus detection of the object is alternately performed with the AF sensor 254 and the image sensor 201. Considering that the object gradually moves, it is preferred that the offset information is calculated by using the preceding and succeeding focus detection results.

Referring to FIG. 7D, the offset information table in this embodiment will be described. FIG. 7D is an explanatory diagram of the offset information table. The offset information table (offset information 730) is stored in the SDRAM 209, for example. The offset information 730 increases each time the process of step S415 is performed. In the example of FIG. 7D, two pairs of pieces of offset information (offset information corresponding to two indices) of a row 731 and a row 735 are stored since the process of step S415 is performed twice.

The offset information of a first process in step S419 includes a focus detection amount 732 by the AF sensor 254, a focus detection amount 733 by the image sensor 201, and an offset amount 734. However, the first offset amount 734 is blank. The offset information of a second process in step S419 includes a focus detection amount 736 by the AF sensor 254, a focus detection amount 737 by the image sensor 201, and an offset amount 738. The number of indices may be increased infinitely, or the table may be reused by determining the upper limit and looping.

Next, the still image capturing process flow of FIG. 4 will be described. Here, only processes different from those in the first embodiment will be described. In step S401, the user turns on (presses halfway) SW1 to place the object in the viewfinder in order to capture a still image, and then, in step S405, SW2 is turned on (fully pressed) to start continuous still image capturing.

When SW2 is kept on (fully pressed) in step S414, the camera controller 212 adds the index information table of the row 731 (index 1) in the offset information 730 in step S415. Then, the camera controller 212 stores the focus detection amount 733 by the image sensor 201 in the SDRAM 209. In step S417, the camera controller 212 stores the focus detection amount 732 by the AF sensor 254 in the SDRAM 209. Subsequently, in step S418, it is assumed that the object exists within the range of the focus detection area of the AF sensor 254, and the process proceeds to step S419. In step S419, since the process is the first process, the camera controller 212 does not calculate the offset amount.

After that, when SW2 remains on (fully pressed) in step S414, the camera controller 212 adds the index information table of the row 735 (index 2) of the offset information 730 in step S415. Then, the camera controller 212 stores the focus detection amount 737 by the image sensor 201 in the SDRAM 209. In step S417, the camera controller 212 stores the focus detection amount 736 by the AF sensor 254 in the SDRAM 209. Subsequently, in step S418, it is assumed that the object exists within the range of the focus detection area of the AF sensor 254, and the process proceeds to step S419. In step S419, the camera controller 212 calculates the offset information.

As described above, the camera controller 212 alternately performs the focus detection by the image sensor 201 and the focus detection by the AF sensor 254. Therefore, it is preferred that the offset amount for the image sensor 201 is calculated from the preceding and succeeding focus detection amounts of the AF sensors 254.

Offset amount to be calculated: Of1

Previous focus detection amount 732 of the AF sensor: E0

Current focus detection amount 736 of the AF sensor: E1

Current focus detection amount 737 of the image sensor: D1

The offset amount Of1 is represented by expression (14) below.

Of1=(E0+E1)/2−D1 (14)

When specific numerical values are substituted in expression (14), expression (15) is obtained.

(1000+1100)/2−1000=50 (15)

The camera controller 212 records the offset amount Of1=50 as the offset amount 738 of the offset information 730. The subsequent processes and operations are the same as those in the first embodiment.

According to this embodiment, by adding the offset amount by alternately performing the focus detection using the AF sensor and the image sensor, it is possible to reduce the stepped operation and the hunting operation due to the difference between the focus detection results by the two AF methods. Further, according to this embodiment, it is possible to reduce these operations with a small calculation amount without storing a large capacity table.

### Fifth Embodiment

Next, a fifth embodiment of the present invention will be described. This embodiment is the same as the first embodiment except for the offset information and the still image capturing process flow. In this embodiment, the focus detection is performed by the AF sensor 254 with respect to an area close to the center within the range of the focus detection area of the AF sensor 254, and the focus detection is performed by the image sensor 201 with respect to the outside of the focus detection area of the AF sensor 254. In this embodiment, while the offset amount is used in a transition area of the two AF methods, the offset amount is set to 0 in a peripheral area so that the focus detection by the image sensor 201 is purely performed.

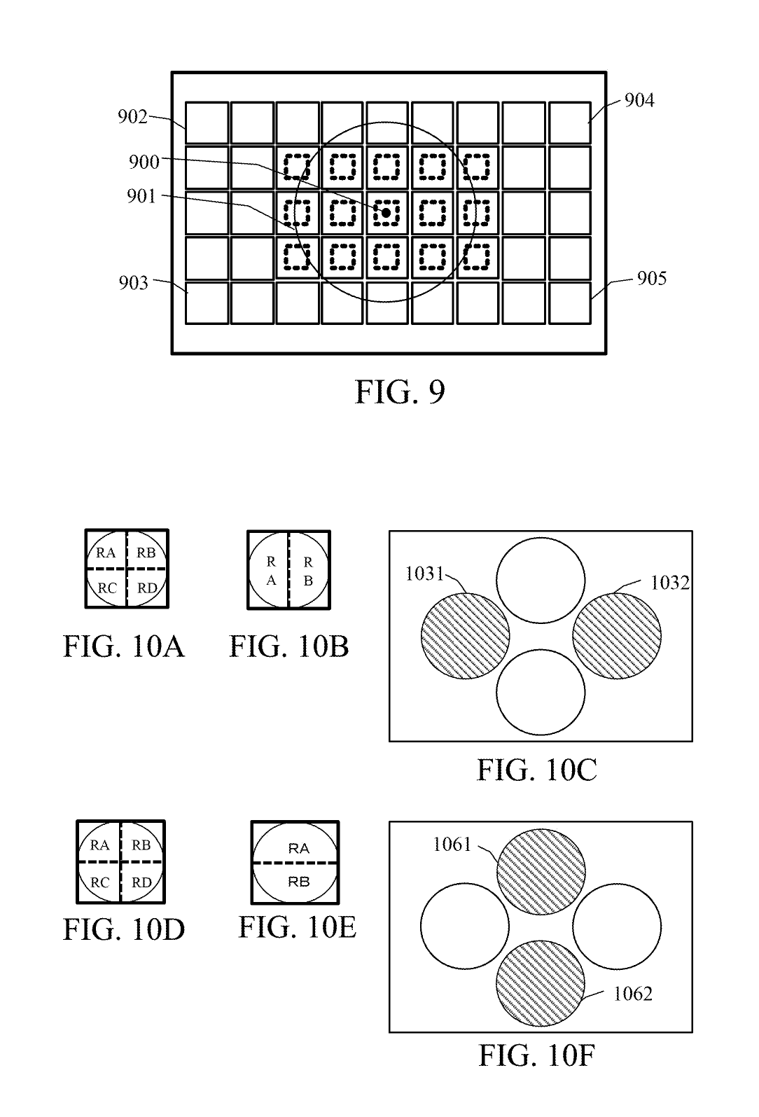

The offset information (storage table of the offset information) in this embodiment is the same as the offset information 700 illustrated in FIG. 7A described in the first embodiment. FIG. 9 is a diagram illustrating the relationship between the focus detection frame of the image sensor 201 and the image height. The dotted and solid squares in FIG. 9 are the same as those in FIG. 5A.

An origin 900 is a point representing the center of the image sensor 201. The origin 900 is assumed to be a coordinate (0, 0) for convenience. A circle 901 is set to pass through the farthest frame where the focus detection can be performed by the AF sensor 254. It is assumed that the distance from the origin 900 to the circle 901 is 100. Each of frames 902, 903, 904, and 905 is a frame at a position farthest from the origin 900, and the distance from the origin 900 is assumed to be 200 for convenience.

Next, the still image capturing process flow of FIG. 4 will be described. Here, only processes different from those in the first embodiment will be described. In step S401, the user turns on (presses halfway) SW1 to place the object in the viewfinder in order to capture a still image, and then, in step S405, SW2 is turned on (fully pressed) to start continuous still image capturing. When SW2 remains on (fully pressed) in step S414, the camera controller 212 stores the focus detection amount 702 by the image sensor 201 in the SDRAM 209 in step S415. In step S417, the camera controller 212 stores the focus detection amount 701 by the AF sensor 254 in the SDRAM 209. In step S418, it is assumed that the object exists within the range of the focus detection area of the AF sensor 254, and the process proceeds to step S419. In step S419, the camera controller 212 calculates the offset amount using expression (1) and stores it in the SDRAM 209 as the offset amount 703.

It is assumed that SW2 remains on (fully pressed) in step S414 after the object has moved out of the range of the focus detection area of the AF sensor 254. In step S415, the camera controller 212 stores the focus detection amount 737 by the image sensor 201 in the SDRAM 209. In step S417, the camera controller 212 stores the focus detection amount 736 by the AF sensor 254 in the SDRAM 209. In step S418, since the object has moved out of the range of the focus detection area of the AF sensor 254, the process proceeds to step S421.

In step S421, the camera controller 212 drives the focus lens 103 to the in-focus position based on a value obtained by adding the offset amount 703 to the focus detection amount 702 by the image sensor 201 in the offset information 700. Here, the offset amount 703 is entirely used in the frame on the line of the circle 901, which is away from the origin 900, the offset amount is decreased as the distance from the origin 900 increases, and an addition amount of the offset amount is zero at the position of the farthest frames 902 to 905. The distance from the origin 900 to the current object is 150, and a drive amount of the focus lens 103 is obtained by using expression (16) below.

Radius of curvature of the circle 901: R1=100

Distance from the origin 900 to the frames 902 to 905: R2=200

Distance from the origin 900 to the current object: R=150

Current offset amount 703: Of=100

Current focus detection amount 702 by the image sensor: DD=900

Lens drive amount: F

F=DD+Of*(R2−R)/(R2−R1) (16)

In the example of FIG. 9, the lens drive amount F is as represented by expression (17) below.

900+100*(200−150)/(200−100)=950 (17)

That is, the camera controller 212 drives the focus lens 103 by the lens drive amount F=950. The subsequent processes and operations are the same as those in the first embodiment.

According to this embodiment, by decreasing the offset amount further away from the origin, it is possible to reduce the stepped operation and the hunting operation due to the difference between the focus detection results by the two AF methods. Further, according to this embodiment, it is possible to reduce these operations with a small calculation amount without storing a large capacity table.

### Sixth Embodiment

Next, a sixth embodiment of the present invention will be described. This embodiment is the same as the first embodiment except for the offset information and the still image capturing process flow. In this embodiment, similarly to each embodiment described above, the focus detection is performed by the AF sensor 254 with respect to an area close to the center within the range of the focus detection area of the AF sensor 254, and the focus detection is performed by the image sensor 201 with respect to the outside of the focus detection area of the AF sensor 254. In this embodiment, while the offset amount is used in a transition area of the two AF methods, the offset amount is gradually reduced with the passage of time and finally it is set to 0 in a peripheral area so that the focus detection by the image sensor 201 is purely performed.

Referring to FIG. 7E, the offset information table in this embodiment will be described. FIG. 7E is an explanatory diagram of the offset information table. The offset information table (offset information 740) is stored in the SDRAM 209, for example. The offset information 740 includes a focus detection amount 741 by the AF sensor 254, a focus detection amount 742 by the image sensor 201, an offset amount 743, and a time lapse amount 744.

Next, the still image capturing process flow of FIG. 4 will be described. Here, only processes different from those in the first embodiment will be described. In step S401, the user turns on (presses halfway) SW1 to place the object in the viewfinder in order to capture a still image, and then, in step S405, SW2 is turned on (fully pressed) to start continuous still image capturing. At this time point, the camera controller 212 returns the time lapse amount 744 of the offset information 740 to an initial value. In the example of FIG. 7E, the time lapse amount 744 is 30.

When SW2 remains on (fully pressed) in step S414, the camera controller 212 stores the focus detection amount 742 by the image sensor 201 in the SDRAM 209 in step S415. In step S417, the camera controller 212 stores the focus detection amount 741 by the AF sensor 254 in the SDRAM 209. Subsequently, in step S418, it is assumed that the object exists within the range of the focus detection area of the AF sensor 254, and the process proceeds to step S419. In step S419, the camera controller 212 calculates the offset amount 743 using expression (1) and stores it in the SDRAM 209.

It is assumed that SW2 remains on (fully pressed) in step S414 after the object has moved out of the range of the focus detection area of the AF sensor 254. At this time, in step S415, the camera controller 212 stores the focus detection amount 737 by the image sensor 201 in the SDRAM 209. In step S417, the camera controller 212 stores the focus detection amount 736 by the AF sensor 254 in the SDRAM 209.

In step S418, since the object has moved out of the range of the focus detection area of the AF sensor 254, the process proceeds to step S421. In step S421, the camera controller 212 first stores a value obtained by subtracting 1 from a value stored in the SDRAM 209 as the time lapse amount 744 in the SDRAM 209 as the time lapse amount 744. Then, the camera controller 212 drives the focus lens 103 to the in-focus position based on a value obtained by adding the offset amount 743 to the focus detection amount 742 by the image sensor 201. In addition, the camera controller 212 gradually attenuates a use amount of the offset amount (decreases the offset amount) after the object comes out of the range of the focus detection area of the AF sensor 254. When the number of captured still images after the object has come out of the range of the focus detection area is currently 15, the current value of the time lapse amount 744 is 15. Then, the camera controller 212 calculates the drive amount of the focus lens 103 using expression (18) below.

Time lapse amount 744: T=15

Initial value of time lapse amount: T0=30

Current offset amount 743: Of=100

Current focus detection amount 742 by the image sensor: DD=900

Lens drive amount: F

F=DD+Of*T/T0 (18)

In the example of FIG. 7E, the lens drive amount F is calculated as represented by expression (19) below.

900+100*15/30=950 (19)

That is, the camera controller 212 drives the focus lens 103 by the lens drive amount F=950. The subsequent processes and operations are the same as those in the first embodiment.

According to this embodiment, by decreasing the offset amount with the lapse of time after the object is out of the focus detection area of the AF sensor, it is possible to reduce the stepped operation and the hunting operation due to the difference between the focus detection results by the two AF methods. Further, according to this embodiment, it is possible to reduce these operations with a small calculation amount without storing a large capacity table.

As described above, in each embodiment, the control apparatus (the camera body 20) includes the first focus detector (the focus detection circuit 255 and the camera controller 212), the second focus detector (the AF signal processor 204 and the camera controller 212), the calculator 212a, the memory (the SDRAM 209), the controller 212 b, and the identifier (the camera controller 212). The first focus detector performs the focus detection by the phase difference detection using the first sensor (the AF sensor 254) that receives the light ray formed by the image capturing optical system. The second focus detector performs the focus detection by the phase difference detection using the second sensor (the image sensor 201) that receives the light ray formed by the image capturing optical system. The calculator 212a calculates the correction information (offset amount) corresponding to the difference between the first signal (the first focus detection signal) from the first detector and the second signal (the second focus detection signal) from the second detector. The memory stores the correction information calculated by the calculator 212a. The controller 212b performs the focus control based on the first signal in the first area and perform the focus control based on the second signal and the correction information stored in the memory in the second area. The identifier identifies the object. The memory stores the correction information for each object identified by the identifier (see FIG. 7B).

Preferably, the first area is the central area (the frame 501) in the captured image (captured screen), and the second area is the peripheral area (frame 502-frame 501) surrounding the central area. Preferably, the first sensor is the AF sensor 254 capable of performing the focus detection in the first area, and the second sensor is the image sensor (image pickup element) 201 capable of performing the focus detection in each of the first area and the second area. Preferably, when the object exists in the first area, the controller 212b performs the focus control based on the first signal and stores the correction information in the memory. When the object exists in the second area, the controller 212b performs the focus control based on the second signal and the correction information stored in the memory.

Preferably, the control apparatus includes the position detector (the camera controller 212) that detects the position of the object (i.e., the coordinate of the object in the direction of the phase difference detection by the image sensor 201, for example, the X coordinate). The memory stores the correction information for each position of the object detected by the position detector (see FIG. 7C). More preferably, when the object exists in the second area and the correction information corresponding to the position of the object is stored in the memory, the controller performs the focus control based on the correction information. On the other hand, when the object exists in the second area and the correction information corresponding to the position of the object is not stored in the memory, the controller calculates the correction information by the interpolation calculation using the plurality of pieces of correction information stored in the memory. Then, the controller performs the focus control based on the correction information calculated by the interpolation calculation.

Preferably, the calculator calculates the difference based on a difference of times at which the first sensor and the second sensor receive the light rays formed by the image capturing optical system. Preferably, the controller performs the focus control with the first correction amount corresponding to the correction information in the first partial area of the second area (i.e., the area closer to the first area). On the other hand, the controller performs the focus control with the second correction amount that is smaller than the first correction amount corresponding to the correction information in the second partial area farther from the first area than the first partial area of the second area (i.e., the area father from the first area). Preferably, when the elapsed time since the object is moved from the first area to the second area is the first elapsed time, the controller performs the focus control with the first correction amount corresponding to the correction information. On the other hand, when the elapsed time is the second elapsed time that is longer than the first elapsed time, the controller performs the focus control with the second correction amount that is smaller than the first correction amount corresponding to the correction information. Preferably, the first focus detector performs the focus detection by the correlation calculation shift in the first direction (at least one direction), and the second focus detector performs the focus detection by the correlation calculation shift in the second direction (at least one direction). Then, the calculator calculates the difference obtained by the focus detection together with the first direction and the second direction.

Preferably, the camera body 20 includes the half mirror (the quick return mirror 252) that is retreatable from the optical path of the light ray formed by the image capturing optical system, and the finder 256 for observing the light ray reflected by the half mirror. The first sensor receives the light ray that is formed by the image capturing optical system and that transmits through the half mirror. The second sensor receives the light ray formed by the image capturing optical system while the half mirror retreats from the optical path.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium′) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to each embodiment, it is possible to provide a control apparatus, an image capturing apparatus, a control method, and a non-transitory computer-readable storage medium that can perform focus detection with high speed and high accuracy at low cost.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-077214, filed on Apr. 13, 2018, which is hereby incorporated by reference herein in its entirety.

What is claimed is:

1. A control apparatus comprising:
a first focus detector configured to perform focus detection by phase difference detection using a first sensor that receives a light ray formed by an image capturing optical system;
a second focus detector configured to perform focus detection by phase difference detection using a second sensor that receives a light ray formed by the image capturing optical system;
a calculator configured to calculate correction information corresponding to a difference between a first signal from the first detector and a second signal from the second detector;
a memory configured to store the correction information calculated by the calculator;
a controller configured to perform focus control based on the first signal in a first area and perform the focus control based on the second signal and the correction information stored in the memory in a second area; and
an identifier configured to identify an object,
wherein the memory is configured to store the correction information for each object identified by the identifier.

2. The control apparatus according to claim 1, wherein the first area is a central area in a captured image, and the second area is a peripheral area surrounding the central area.

3. The control apparatus according to claim 1, wherein:
the first sensor is an AF sensor capable of performing the focus detection in the first area, and
the second sensor is an image sensor capable of performing the focus detection in each of the first area and the second area.

4. The control apparatus according to claim 1, wherein:
when the object exists in the first area, the controller is configured to perform the focus control based on the first signal and store the correction information in the memory, and
when the object exists in the second area, the controller is configured to perform the focus control based on the second signal and the correction information stored in the memory.

5. The control apparatus according to claim 4, further comprising a position detector configured to detect a position of the object,
wherein the memory is configured to store the correction information for each position of the object detected by the position detector.

6. The control apparatus according to claim 5, wherein:
when the object exists in the second area and the correction information corresponding to the position of the object is stored in the memory, the controller is configured to perform the focus control based on the correction information, and
when the object exists in the second area and the correction information corresponding to the position of the object is not stored in the memory, the controller is configured to calculate correction information by an interpolation calculation using a plurality of pieces of correction information stored in the memory, and perform the focus control based on the correction information calculated by the interpolation calculation.

7. The control apparatus according to claim 1, wherein the calculator is configured to calculate the difference based on a difference of times at which the first sensor and the second sensor receive the light rays formed by the image capturing optical system.

8. The control apparatus according to claim 1, wherein the controller is configured to:
perform the focus control with a first correction amount corresponding to the correction information in a first partial area of the second area, and
perform the focus control with a second correction amount that is smaller than the first correction amount corresponding to the correction information in a second partial area of the second area, the second partial area being farther from the first area than the first partial area.

9. The control apparatus according to claim 1, wherein:
when an elapsed time since the object is moved from the first area to the second area is a first elapsed time, the controller is configured to perform the focus control with a first correction amount corresponding to the correction information, and
when the elapsed time is a second elapsed time that is longer than the first elapsed time, the controller is configured to perform the focus control with a second correction amount that is smaller than the first correction amount corresponding to the correction information.

10. The control apparatus according to claim 1, wherein:
the first focus detector is configured to perform the focus detection by a correlation calculation shift in a first direction,
the second focus detector is configured to perform the focus detection by the correlation calculation shift in a second direction, and
the calculator is configured to calculate the difference obtained by the focus detection together with the first direction and the second direction.

11. An image capturing apparatus comprising:
a first sensor configured to receive a light ray formed by an image capturing optical system;
a first focus detector configured to perform focus detection by phase difference detection using the first sensor;
a second sensor configured to receive a light ray formed by the image capturing optical system;
a second focus detector configured to perform focus detection by phase difference detection using the second sensor;
a calculator configured to calculate correction information corresponding to a difference between a first signal from the first detector and a second signal from the second detector;
a memory configured to store the correction information calculated by the calculator;
a controller configured to perform focus control based on the first signal in a first area and perform the focus control based on the second signal and the correction information stored in the memory in a second area; and
an identifier configured to identify an object,
wherein the memory is configured to store the correction information for each object identified by the identifier.

12. The image capturing apparatus according to claim 11, further comprising:
a half mirror configured to be retreatable from an optical path of the light ray formed by the image capturing optical system; and
a finder configured to observe the light ray reflected by the half mirror,
wherein the first sensor is configured to receive the light ray that is formed by the image capturing optical system and that transmits through the half mirror, and
wherein the second sensor is configured to receive the light ray formed by the image capturing optical system while the half minor retreats from the optical path.

13. A control method comprising the steps of:
performing first focus detection by phase difference detection using a first sensor that receives a light ray formed by an image capturing optical system;
performing second focus detection by phase difference detection using a second sensor that receives a light ray formed by the image capturing optical system;
calculating correction information corresponding to a difference between a first signal obtained by the first detection and a second signal obtained by the second detection;
storing the calculated correction information;
performing focus control based on the first signal in a first area;
performing the focus control based on the second signal and the stored correction information; and
identifying an object,
wherein the step of storing the correction information includes storing the correction information for each object identified by the identifier.

14. A non-transitory computer-readable storage medium which stores a program causing a computer to execute a process comprising the steps of:
performing first focus detection by phase difference detection using a first sensor that receives a light ray formed by an image capturing optical system;
performing second focus detection by phase difference detection using a second sensor that receives a light ray formed by the image capturing optical system;
calculating correction information corresponding to a difference between a first signal obtained by the first detection and a second signal obtained by the second detection;
storing the calculated correction information;
performing focus control based on the first signal in a first area;
performing the focus control based on the second signal and the stored correction information; and
identifying an object,
wherein the step of storing the correction infolliiation includes storing the correction information for each object identified by the identifier.
